(19) United States
(12) Patent Application Publication
(10) Pub. No.: US 2011/0011907 A1
(43) Pub. Date: Jan. 20, 2011

(54) DEVICES FOR SECURING PERSONAL-TRANSPORT VEHICLES TO MOUNTING SURFACES

(75) Inventors: Thomas A. Panzarella, Harleysville, PA (US); James B. Eldon, III, Barto, PA (US); David D. McClanahan, Harleysville, PA (US)

Correspondence Address: FOX ROTHSCHILD LLP, 997 Lenox Drive, Bldg. #3, Lawrenceville, NJ, 08648, US

(73) Assignees: FREEDOM SCIENCES, LLC, Philadelphia, PA (US); COOK TECHNOLOGIES, INC. d/b/a FREEDOM LIFT CORPORATION, Green Lane, PA (US)

(21) Appl. No.: 12/667,810

(22) PCT Filed: Jul. 11, 2008
(86) PCT No.: PCT/US08/69772

§ 371 Date: Feb. 26, 2010

Related U.S. Application Data
(60) Provisional application No. 60/949,166, filed on Jul. 11, 2007.

(51) Int. Cl. B60R 9/00

(52) U.S. Cl. 224/407

(57) ABSTRACT

Embodiments of devices for securing a personal-transport vehicle to a mounting surface can include features that (i) permit the personal-transport vehicle to be released from the device by manually depressing a pushbutton on the device; (ii) facilitate adjustment of the position of the device in relation to the mounting surface; and/or (iii) prevent the personal-transport vehicle from being released in an unsafe manner.

### TECHNICAL FIELD

The disclosed embodiments relate to a device for securing a personal-transport vehicle such as a power chair to a mounting surface such as a platform of a lift and carrier assembly.

### BACKGROUND

Personal-transport vehicles such as power chairs are commonly used by individuals with ambulatory difficulties or other disabilities. Various types of lift and carrier assemblies have been developed to facilitate the transportation of power chairs using passenger cars and other motorized vehicles. Lift and carrier assemblies are typically mounted on a trailer hitch or similar connecting point on the motorized vehicle. The power chair rides outside of the motorized vehicle on a platform or similar-type component of the lift and carrier assembly. The lift and carrier assembly typically includes provisions that permit the power chair to be driven onto the platform at ground level, and then lifted to prevent contact with the road surface during transport.

Lift and carrier assemblies usually include some type of mechanism that automatically secures the power chair in place during transport. For example, the lift and carrier assembly may be equipped with straps. Alternatively, the lift and carrier assembly may be equipped with a lever arm adapted to exert a substantial downward force on the power chair by way of a padded foot or other suitable member. The lever arm may be adapted to automatically rotate the foot into and out of contact with the power chair as the platform is moved between its upper and lower positions.

The use of a lever arm to secure the power chair requires that the power chair have a rigid surface that is within the range of motion of the securing foot. Moreover, the rigid surface must be able to withstand the substantial downward force exerted by the foot. Many contemporary personal-transport vehicles, e.g., power chairs, are typically not equipped with a surface that satisfies these requirements. Hence, securing devices that rely on a lever arm and foot are incompatible with many applications.

Because lift and carrier assemblies are often used by mobility-impaired individuals, releasing the personal-transport vehicles from the securing device can be difficult or impossible for some users if the release feature cannot be easily accessed or actuated. Also, it may be unfeasible to mount the securing device at a location on the mounting surface that places the personal-transport vehicle at a desired location or orientation when the personal-transport vehicle is mated to the securing device. For example, bumps, structural members, and other obstacles can make it difficult or otherwise unfeasible to mount the securing device at an optimal location on the mounting surface. Moreover, inadvertent or accidental release the personal-transport vehicle from the securing device when the transporting vehicle is not safely parked can present a serious safety hazard.

### SUMMARY

Embodiments of devices for securing a personal-transport vehicle to a mounting surface can include features that (i) permit the personal-transport vehicle to be released from the device by manually depressing a pushbutton on the device; (ii) facilitate adjustment of the position of the device in relation to the mounting surface; and/or (iii) prevent the personal-transport vehicle from being released in an unsafe manner.

Embodiments of devices for securing a personal-transport vehicle to a mounting surface comprise a plow bracket or a bracket member for mounting on the personal-transport vehicle or the mounting surface, and a receptacle for mating with the plow bracket or the bracket member. The receptacle comprises a yoke bracket for mounting on the personal-transport vehicle or the mounting surface and receiving the plow bracket or the bracket member. The receptacle also comprises a docking lever pivotally coupled to the yoke bracket and movable between a first position wherein the docking lever can securely engage the plow bracket of the bracket member and thereby retain the receptacle and the plow bracket or bracket member in a mated condition, and a second position.

The devices also comprise a pawl assembly. The pawl assembly comprises a shaft rotatably coupled to the yoke bracket, and a pin mounted on the shaft. The pawl assembly also comprises a pawl mounted on the shaft so that the pawl can pivot between an engaged position wherein the pawl restrains the docking lever in the first position, and a disengaged position.

The devices also comprise a pushbutton coupled to the yoke bracket and movable between a first and a second position in relation to the yoke bracket. The pushbutton engages the pin as the pushbutton moves between the first and second positions of the pushbutton so that movement of the pushbutton between the first and second positions of the pushbutton imparts rotation to the shaft that causes the pawl to pivot between the engaged and disengaged positions.

Other embodiments of devices for securing a personal-transport vehicle to a mounting surface comprise a plow bracket or a bracket member for mounting on the personal-transport vehicle or the mounting surface, and a receptacle for mating with the plow bracket or the bracket member. The receptacle comprises a yoke bracket for mounting on the personal-transport vehicle or the mounting surface and receiving the plow bracket or the bracket member. The receptacle also comprises a docking lever pivotally coupled to the yoke bracket and movable between a first position wherein the docking lever can securely engage the plow bracket of the bracket member and thereby retain the receptacle and the plow bracket or bracket member in a mated condition, and a second position.

The devices also comprise a pawl assembly. The pawl assembly comprises a shaft rotatably coupled to the yoke bracket. The pawl assembly also comprises a pawl mounted on the shaft so that the pawl can pivot between an engaged position wherein the pawl restrains the docking lever in the first position, and a disengaged position.

The devices also comprise a plurality of fasteners each having a head, a shaft, and a square portion located between the shaft and the head. The devices further comprise a plurality of washers each having two tongue-shaped end portions, and a middle portion capable of engaging an associated one of the fasteners.

The devices also comprise a base capable of being mounted on the mounting surface and supporting the receptacle on the mounting surface. The base has a plurality of slots formed therein. Each of the slots has a plurality of small-width portions and a plurality of large-width portions arranged in an alternating manner. The large width portions are sized to permit the head of an associated one of the fasteners to pass therethrough. The small-width portions are sized to securely engage the square portion of an associated one of the fasteners. The tongue-shaped portions of each of the washers are sized to fit snugly within the large-width portion of an associated one of the slots so that the washers prevent the fasteners from moving forward and rearward in relation to the base.

Other embodiments of devices for securing a personal-transport vehicle to a mounting surface comprise a plow bracket or a bracket member for mounting on the personal-transport vehicle or the mounting surface, and a receptacle for mating with the plow bracket or the bracket member. The receptacle comprises a yoke bracket for mounting on the personal-transport vehicle or the mounting surface and receiving the plow bracket or the bracket member. The receptacle also comprises a docking lever pivotally coupled to the yoke bracket and movable between a first position wherein the docking lever can securely engage the plow bracket of the bracket member and thereby retain the receptacle and the plow bracket or bracket member in a mated condition, and a second position.

The devices also comprise a pawl assembly. The pawl assembly comprises a shaft rotatably coupled to the yoke bracket. The pawl assembly also comprises a pawl mounted on the shaft so that the pawl can pivot between an engaged position wherein the pawl restrains the docking lever in the first position, and a disengaged position.

The devices further comprise a solenoid mechanically coupled to the pawl assembly so that the solenoid causes the pawl to move to the disengaged position when the solenoid is activated.

The devices also comprise a release system comprising a pushbutton switch movable between a first and a second position, and a processor capable of being communicatively coupled to an ignition switch of the transporting vehicle. The processor sends power to the solenoid to activate the solenoid when the pushbutton switch is moved to the second position and the ignition switch is an off position.

### BRIEF DESCRIPTION OF THE DRAWINGS

The foregoing summary, as well as the following detailed description of a presently-preferred embodiment, is better understood when read in conjunction with the appended drawings. For the purpose of illustrating the invention, the drawings show an embodiment that is presently preferred. The invention is not limited, however, to the specific instrumentalities disclosed in the drawings. In the drawings:

FIG. 1A is a perspective view of an embodiment of a device installed on a platform of a lift and carrier assembly, with wiring of the device routed internally to the lift and carrier assembly;

FIG. 1B is a perspective view of the device and lift and carrier assembly shown in FIG. 1A, with the wiring of the device routed externally to the lift and carrier assembly;

FIGS. 2A-2E are side views of the device shown in FIGS. 1A and 1B, as a plow bracket of the device is mated and unmated with a receptacle of the device (a first pawl, a shaft, and an electric solenoid of the device are not shown in FIG. 2E, for clarity);

FIGS. 3A and 3B are side views of the device shown in FIGS. 2A-2E, from a perspective rotated approximately 180 degrees from the perspective of FIGS. 2A-2E, as the plow bracket is mated and unmated with the receptacle;

FIG. 4 is a perspective view of the receptacle and a mounting bracket of the device shown in FIGS. 1A-3B, mounted on a platform of the lift and carrier assembly shown in FIGS. 1A and 1B;

FIGS. 4A and 4B are magnified top views of the areas designated “A” and “B,” respectively, in FIG. 4;

FIGS. 5 and 6 are perspective view of a plow bracket of the device shown in FIGS. 1A-4;

FIG. 7 is a perspective view of a power chair having the plow bracket shown in FIGS. 5 and 6 installed thereon;

FIG. 8 is a cross-sectional perspective view of the power chair shown in FIG. 7 and the plow bracket shown in FIGS. 5-7;

FIG. 9 is a partially exploded view of an alternative embodiment of the plow bracket shown in FIGS. 5-7;

FIG. 10 is a perspective view of the power chair shown in FIG. 7 and the plow bracket shown in FIGS. 5-7, taken through the line “A-A” of FIG. 7;

FIG. 11 is a is a perspective view of a pawl assembly of the device shown in FIGS. 1A-4;

FIG. 12 is another alternative embodiment of the plow bracket shown in FIGS. 5-7 and 10;

FIGS. 13A and 13B are side views of an alternative embodiment of the device shown in FIGS. 1A-4, depicting a second pawl of the device in an engaged and a disengaged position;

FIGS. 14A-14C are side views of the alternative embodiment of the device shown in FIGS. 13A and 13B, showing a toggle of the device in conditions restraining and releasing a second pawl of the device;

FIG. 15 is a side view of a trigger of the device shown in FIGS. 1A-3B;

FIG. 16 is a side view of a pawl of the device shown in FIGS. 1A-3B;

FIG. 17 is a perspective view of an alternative embodiment of a receptacle of the device shown in FIGS. 1A-3B

FIG. 18 is an exploded perspective view of a receptacle, a release assembly, and a pawl assembly of an alternative embodiment of the device shown in FIGS. 1A-3B;

FIG. 19 is a perspective view of the receptacle, the release assembly, and the pawl assembly shown in FIG. 18, and a plow bracket of the alternative embodiment of the device shown in FIGS. 1A-3B mated with the receptacle, with a release lever and a first pawl of the device shown in their respective second positions, and a first docking lever of the receptacle shown in its locking position;

FIG. 20 is a perspective view of the receptacle, the release assembly, the pawl assembly, the plow bracket, and the platform shown in FIGS. 18 and 19, with the release lever and the first pawl shown in their respective first positions, and the first docking lever shown in its releasing position;

FIG. 21 is a perspective view of the receptacle, the release assembly, the pawl assembly, and the platform shown in FIGS. 18-20, with the release lever and the first pawl shown in their respective second positions, and the first docking lever shown in its locking position;

FIG. 22 is a side view of the receptacle, the release assembly, the pawl assembly, and the plow bracket shown in FIGS. 18-21, with the release lever shown in its first position, the first pawl shown in its first position and restrained by the first docking lever, the first docking lever shown in its releasing position, and the plow bracket fully inserted in the receptacle;

FIG. 23 is a side view of the receptacle, the release assembly, the pawl assembly, and the plow bracket shown in FIGS. 18-22, from a perspective 180-degrees reversed from that of FIG. 21, with a second pawl of the device shown in is first position, a second docking lever of the device shown in its releasing position, and the plow bracket fully inserted in the receptacle;

FIG. 24 is a side view of the receptacle, the release assembly, the pawl assembly, and the plow bracket shown in FIGS. 18-23, taken from the perspective of FIG. 22, with the release lever shown in its second position, the first pawl shown in its second position, the first docking lever arm in its locking position and securing a first trunnion of the plow bracket, and the plow bracket fully inserted in the receptacle;

FIG. 25 is a side view of the receptacle, the pawl assembly, and the plow bracket shown in FIGS. 18-24, taken from the perspective of FIGS. 22 and 24, immediately after first pawl has been released from the first docking lever, and with the plow bracket being withdrawn from the receptacle;

FIG. 26 is a side view of the receptacle, the pawl assembly, and the plow bracket shown in FIGS. 18-25, taken from the perspective of FIGS. 22, 24, and 25, after the first pawl has been released from the first docking lever, and with the plow bracket being withdrawn from the receptacle;

FIG. 27 is a side view of the receptacle, the pawl assembly, and the plow bracket shown in FIGS. 18-26, taken from the perspective of FIGS. 22 and 24-26, as the plow bracket is being inserted into (or backing out of) the receptacle, with the first docking lever shown in its locking position and the first pawl shown in its second position;

FIG. 28 is a side view of the receptacle, the pawl assembly, and the plow bracket shown in FIGS. 18-27, taken from the perspective of FIGS. 22 and 24-27, as the plow bracket is further inserted into the receptacle and the first docking lever is moving from its locking to its releasing position, with the first pawl shown in its second position;

FIG. 29 is a perspective side view of a device comprising an alternative embodiment of the receptacle shown in FIGS. 18-28 and;

FIGS. 30A and 30B are perspective views of the device shown in FIGS. 1A-3B, with the receptacle of the device installed on the floorboard of a van, and the power chair shown in FIGS. 7 and 10 approaching the receptacle and mated with the receptacle, respectively.

FIG. 31 is a perspective view of an alternative embodiment of the device shown in FIGS. 1A-3B, 30A, and 30B;

FIG. 32 is a partially exploded view of the device shown in FIG. 31;

FIG. 33 is an exploded view of the device shown in FIGS. 31 and 32;

FIG. 34 is a longitudinal cross-sectional view of the device shown in FIGS. 31-33;

FIG. 35 is a perspective view of a bezel of the device shown in FIGS. 31-34;

FIGS. 36A-36H are perspective views of a pushbutton of the device shown in FIGS. 31-35;

FIG. 37 is a block diagram depicting electrical components of the device shown in FIGS. 31-36H;

FIG. 38 is a perspective view of a bracket of a manual release system of the device shown in FIGS. 31-37;

FIG. 39 is an exploded perspective view of a portion of the device shown in FIGS. 31-38;

FIG. 40 is a perspective view of various components for mounting the device shown in FIGS. 31-39;

FIG. 41 is an exploded view of the device shown in FIGS. 31-40;

FIGS. 42A and 42B are perspective views of a pushbutton module, processing module, and a mounting bracket of the device shown in FIGS. 31-41;

FIGS. 43A and 43B are perspective views of a manual release system of the device shown in FIGS. 31-42A;

FIG. 44 is a schematic illustration of a the processing device and the pushbutton module of the device shown in FIGS. 31-43B;

FIGS. 45A-45D are various views of a cable and connector for interconnecting the processing device with other components of the device shown in FIGS. 39-44; and

FIGS. 46A-46F depict a solenoid and related components of the device shown in FIGS. 31-44.

### DETAILED DESCRIPTION

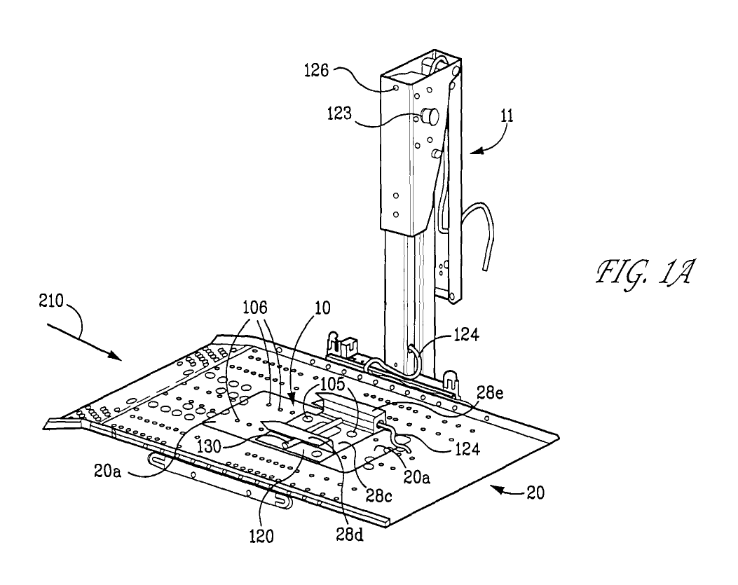

FIGS. 1A-11, 15, and 16 depict an embodiment of a device 10 (or individual components thereof) for securing a personal-transport vehicle, such as a power chair, wheelchair, scooter, etc., to a platform or other supporting surface. The platform can be part of a lift and carrier assembly 11 (see FIGS. 1A and 1B) installed on a motorized vehicle such as an automobile, van, pickup truck, etc. (hereinafter referred to as a “transporting vehicle”). The lift and carrier assembly 11 can raise and lower the platform between a lower position proximate the ground, and an upper position. The personal-transport vehicle can be loaded onto the lift and carrier assembly 11 while the platform is in the lower position. The personal-transport vehicle can be transported while the platform is in the upper position.

Alternatively, the device 10 can be mounted on a floorboard, bed, or other suitable surface of the transporting vehicle. For example, the device 10 can be mounted on a floorboard of a van, the bed of a pickup truck, or the bottom surface of a trunk of an automobile, and the personal-transport vehicle can be lifted using a conventional hoist-type lift.

The device 10 comprises a plow bracket 16, and a receptacle 18. The plow bracket 16 can be fixedly coupled to a personal-transport vehicle such as a power chair 14 (see FIGS. 7 and 10). The receptacle 18 can be fixedly coupled to a platform 20 of the lift and carrier assembly 11 (or other suitable mounting surface) (see FIGS. 1A and 1B). The receptacle 18 can securely receive the plow bracket 16 when the power chair 14 is driven onto the platform 20, as explained in detail below.

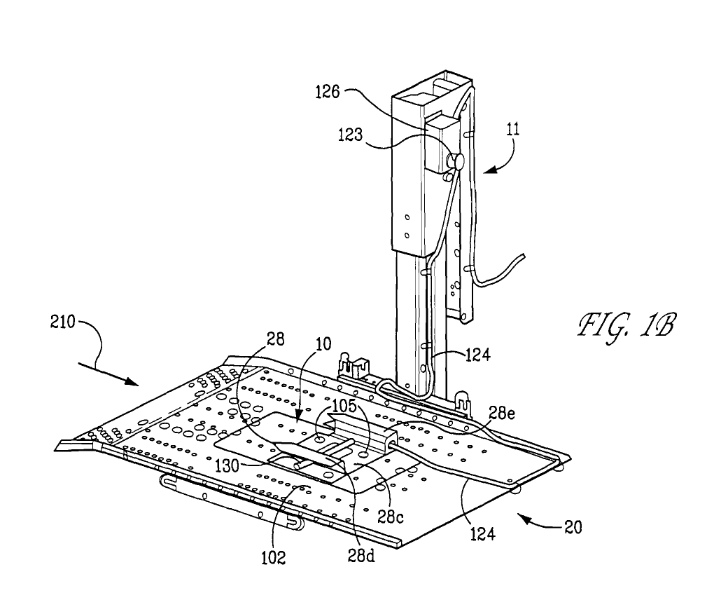

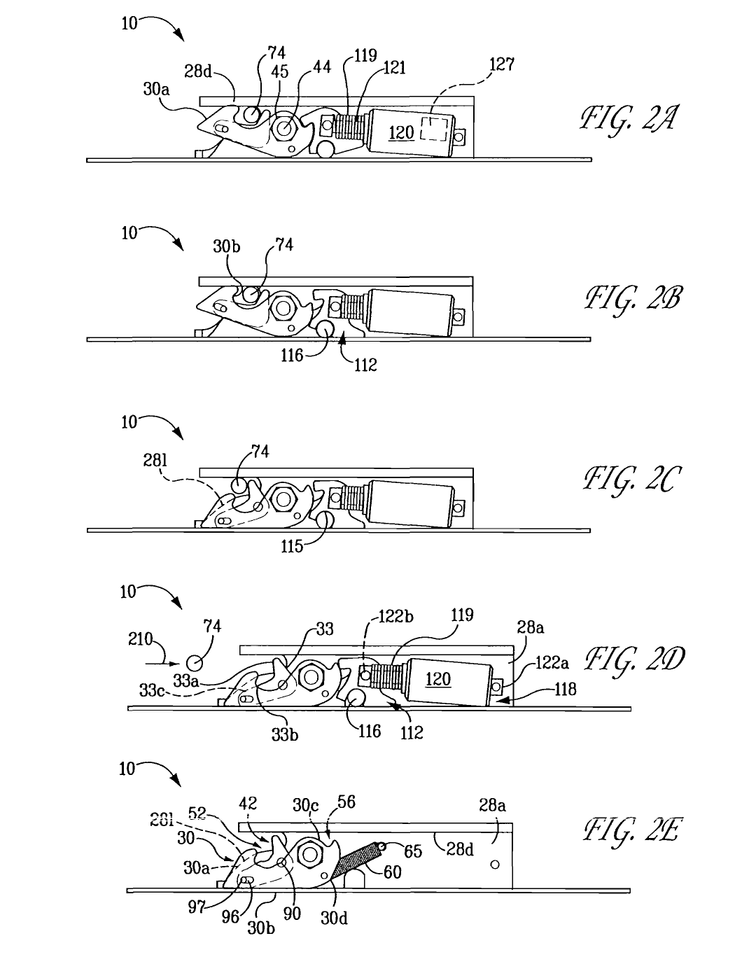

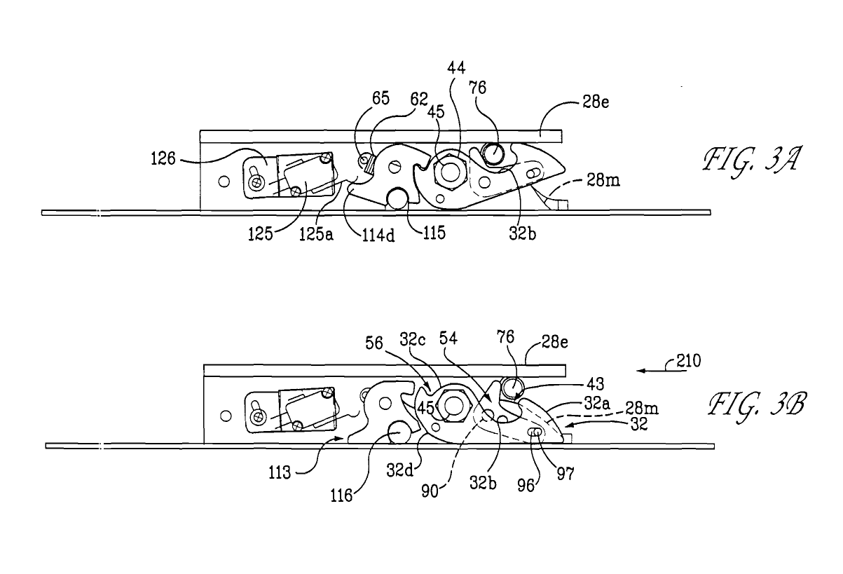

The receptacle 18 comprises a yoke bracket 28, a first (or master) docking lever 30, and a second (or slave) docking lever 32 (see, e.g., FIGS. 2A-2E, 3A, and 3B). The first and second docking levers 30, 32 are pivotally coupled to the yoke bracket 28, as discussed below. The receptacle 18 also comprises a first trigger 33, and a second trigger 34. The first and second triggers 33, 34 are pivotally coupled to the respective first and second docking levers 30, 32, and to the yoke bracket 28.

The yoke bracket 28 comprises a first and a second side panel 28a, 28b, and a bottom panel 28c (see, e.g., FIGS. 1A-1B). The side panels 28a, 28b adjoin opposing ends the bottom panel 28c, and are substantially perpendicular to the bottom panel 28c.

The yoke bracket 28 also comprises a first and a second wing member 28d, 28e. The first and second wing members 28d, 28e adjoin the respective first and second side panels 28a, 28b.

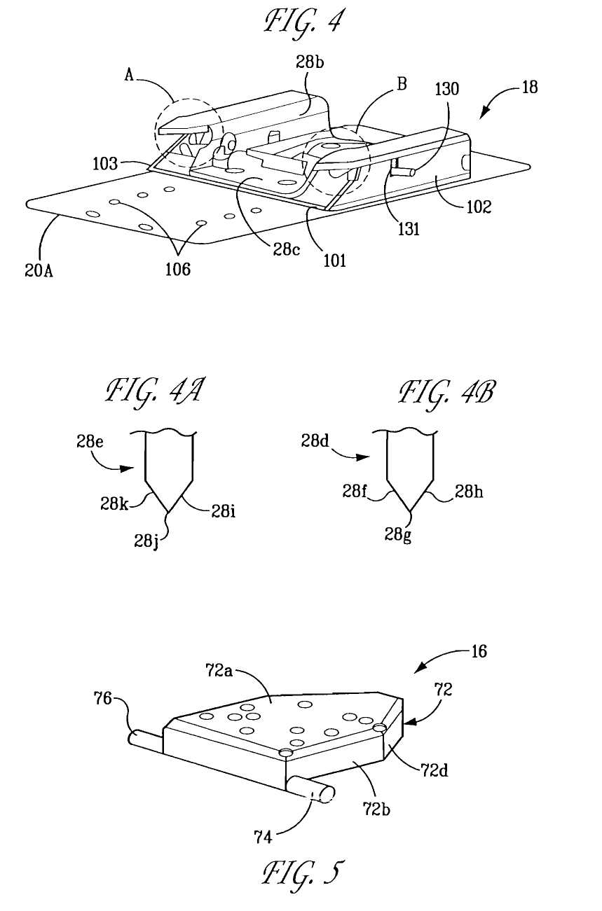

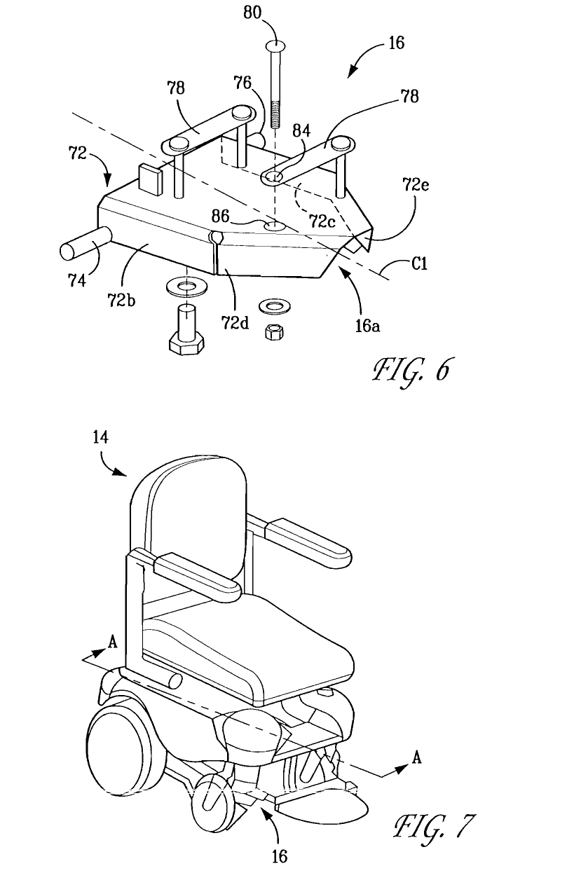

The first wing member 28d preferably has a substantially straight first edge portion 28f, and a curved second edge portion 28g that adjoins the first edge portion 28f (see FIG. 4B). The first wing member 28d also preferably includes a substantially straight third edge portion 28h that adjoins the second edge portion 28g.

The first, second, and third edge portions 28f, 28g, 28h define a forward end of the first wing member 28d. The first and third edge portions 28f, 28h are preferably oriented at an acute angle in relation to reach other. This feature gives the forward end of the first wing member 28 a substantially V-shaped profile, as shown in FIG. 4B.

The second wing member 28e preferably has a substantially straight first edge portion 28i, and a curved second edge portion 28j that adjoins the first edge portion 28i (see FIG. 4A). The second wing member 28e also preferably includes a substantially straight third edge portion 28k that adjoins the second edge portion 28j.

The first, second, and third edge portions 28i, 28j, 28k define a forward end of the second wing member 28e, and are substantially identical to the first, second, and third edge portions 28f, 28g, 28h of the first wing member 28a.

The first side panel 28a has a first edge portion 28e, and the second side panel 28b has a first edge portion 28m (see FIGS. 2A-2E, 3A, and 3B). The first edge portion 28l defines an open-ended slot 42. The first edge portion 28m defines an open-ended slot 43.

The first and second docking levers 30, 32 are pivotally coupled to the yoke arm 28, as previously noted. More particularly, the first docking lever 30 is pivotally coupled to the first side panel 28a by way of a threaded bolt 44. The bolt 44 is accommodated within through holes formed in each of the first side panel 28a and the docking lever 30, and is axially restrained by nuts 45 located on opposing sides of the docking lever 30. (Alternatively, the first docking lever 30 is pivotally coupled to the first side panel 28a by way of a shaft.)

The second docking lever 32 is pivotally coupled to the second side panel 28b by a second of the threaded bolts 44 (or shafts) (see FIGS. 3A and 3B). The second bolt 44 is accommodated within through holes formed in each of the second side panel 28b and the docking lever 32, and is axially restrained by a third and a fourth of the nuts 45, located on opposing sides of the docking lever 32.

The first and second docking levers 30, 32 can pivot between a locking position (see, e.g., FIGS. 2A and 3A) and a releasing position (see, e.g., FIGS. 2E and 3B). The docking levers 30, 32 are pivotally biased in a counterclockwise direction (from the perspective of FIGS. 2A-2E) by respective springs 60, 62 (see, e.g., FIGS. 2E and 3A). In other words, the springs 60, 62 bias the docking levers 30, 32 toward the releasing position.

A first end of each of the springs 60, 62 is retained by an associated pin 65 that extends from the respective first and second side panels 28a, 28b (see FIGS. 2E and 3A). A second end of each of the springs 60, 62 is retained by the respective first and second docking levers 30, 32, and is accommodated in through holes formed therein. The optimal spring rate of the springs 60, 62 is application-dependent. A specific value for this parameter therefore is not presented herein.

The first docking lever 30 has a first edge portion 30a, and a second edge portion 30b that adjoins the first edge portion 30a (see FIGS. 2A-2E). The second edge portion 30b defines a first indentation 52 in the first docking lever 30. The first docking lever 32 has a first edge portion 32a, and a second edge portion 32b that adjoins the first edge portion 32a (see FIGS. 3A, 3B). The second edge portion 32b defines a first indentation 54 in the second docking lever 32.

The first docking lever 30 also has a third edge portion 30c (see FIGS. 2A-2E). The third edge portion 30c defines a second indentation 56 in the first docking lever 30. The first docking lever 30 also includes a fourth edge portion 30d that adjoins the third edge portion 30c.

The second docking lever 32 has a third edge portion 32c (see FIGS. 3A, 3B). The third edge portion 32c defines a second indentation 57 in the first docking lever 30. The second docking lever 32 also includes a fourth edge portion 32d that adjoins the third edge portion 32c.

The first docking lever 30 is restrained from clockwise rotation past its locking position (from the perspective of FIGS. 2A-2E) by the first wing member 28d. More particularly, the first wing member 28d is located above the docking lever 30, and intersects the plane of rotation of the docking lever 30. Clockwise rotation of the docking lever 30 causes a portion of the first edge portion 30a of the first docking lever 30 to contact the wing member 28d as the first docking lever 30 reaches the locking position (see, e.g., FIG. 2A). This contact interferes with further clockwise movement of the first docking lever 30, and thereby prevents the first docking lever 30 from pivoting past its locking position.

The second docking lever 32 is likewise restrained from counterclockwise rotation past is locking position (from the perspective of FIGS. 3A, 3B) by the second wing member 28e. More particularly, the second wing member 28e is likewise located above the second docking lever 32, and intersects the plane of rotation of the second docking lever 32. Counterclockwise rotation of the second docking lever 32 (from the perspective of FIGS. 3A, 3B) causes the first edge portion 32a of the second docking lever 32 to contact the second wing member 28e as the second docking lever 32 reaches the locking position (see FIG. 3A). This contact interferes with further counterclockwise movement of the second docking lever 32, and thereby prevents the second docking lever 32 from pivoting past its locking position.

The first trigger 33 is substantially “L” shaped (see, e.g., FIG. 15). The first trigger 33 has a substantially straight first edge portion 33a, and a curved second edge portion 33b that adjoins the first edge portion 33a. The first trigger 33 also has a substantially straight third edge portion 33c that adjoins the second edge portion 33b.

The first trigger 33 is pivotally coupled to the first side panel 28a of the yoke arm 28, as noted previously. In particular, a first pin 90 is fixedly coupled to, and extends outward from the first side panel 28a (see FIGS. 2A-2E). The first trigger 33 has a first through hole 92 formed proximate a first end thereof (see FIG. 15). The first trigger 33 is mounted on the first pin 90 by way of the first through hole 92. The first trigger 33 can be retained on the first pin 90 using a suitable means such as an E-clip, or a bolt that engages threads formed on an end of the pin 90.

The first trigger 33 is also pivotally coupled to the first docking lever 30. In particular, the first trigger 33 has a second through hole 95 formed proximate a second end thereof (see FIG. 15), and the first docking lever 30 has a slot 96 formed therein (see FIGS. 2A-2E). A second pin 97 extends through and between the slot 96 and the second through hole 95 so as to pivotally couple the first trigger 33 and the first docking lever 30. The second pin 97 can be retained in the slot 96 and the second through hole 95 by a suitable means such as E-clips, or bolts that engage threads formed on opposite ends of the pin 97.

The first trigger 33 pivots about the first pin 90, between a first position (FIG. 2A) and a second position (FIG. 2E) as the first docking lever 30 pivots between its locking and releasing positions. (The slot 96 in the first docking lever 30 permits the second pin 97 to translate linearly, as well as pivotally, in relation to the first docking lever 30, thereby facilitating the noted movement of the first trigger 33 and the first docking lever 30.)

The second trigger 34 is substantially identical to the first trigger 33, and includes first, second, and third edges 34a, 34b, 34c that are substantially identical to the respective first, second, and third edges 33a, 33b, 33c of the first trigger 33 (see FIG. 15). The second trigger 34 also includes first and second through holes 92, 95, and is pivotally coupled to the second docking lever 32 and the second side panel 28b of the yoke arm 28 second arm 28b via a first and second pin 90, 97 as described above in relation to the first trigger 33 (the second docking lever 32 also has one of the slots 96 formed therein to accommodate another of the second pins 97).

The second trigger 34 pivots between a first position (FIG. 3A) and a second position (FIG. 3B) as the second docking lever 32 pivots between its locking and releasing positions, in a manner substantially identical to the first trigger 33.

The device 10 also comprises a pawl assembly 110 (see FIGS. 2A-2E, 3A, 3B, 11, and 16). The pawl assembly 110 comprises a first (or master) pawl 112, a second (or slave) pawl 114, and a shaft 116. The device 10 also includes an electric solenoid 118 and a spring 119 for actuating the first and second pawls 112, 114. (The optimal value for the spring rate of the spring 119 is application-dependent. A particular value for this parameter therefore is not specified herein.)

The first and second side panels 28a, 28b each have a slot 115 formed therein for receiving the shaft 116. The first pawl 112 is fixedly coupled to a first end of the shaft 116, outward of the first side panel 28a. The second pawl 114 is fixedly coupled to a second end of the shaft 116, outward of the second side panel 28b. The first and second pawls 112, 114 each include a slot 117 for accommodating the shaft 116 (see FIG. 15).

The shaft 116 can rotate within the slots 115 formed in the first and second side panels 28a, 28b. This rotation permits the first and second pawls 114, 116 to each move between a first, or engaged position (FIGS. 2A and 3A), and a second, or disengaged position (FIGS. 2D and 3B).

The electric solenoid 118 includes a body 120 and a shaft 121. The shaft 121 extends into and out of the body 120 between a first, or retracted position (FIG. 2C) and a second, or extended position (FIG. 2A). The body 120 is fixedly coupled to the first side panel 28a of the yoke bracket 28 by a first bracket 122a. The shaft 121 is pivotally coupled to the first pawl 112 by a second bracket 122b.

Movement of the shaft 121 between its extended and retracted positions moves the first pawl 112 between its engaged and disengaged positions. (The first and second pawls 112, 114 are fixedly coupled to the shaft 116, as noted above. Movement of the first pawl 112 between its engaged and disengaged positions thus causes the second pawl 114 to move between its respective engaged and disengaged positions.)

The electric solenoid 118 can be actuated, for example, by a palmbutton switch 123 mounted at a suitable location on the lift and carrier assembly 11 (see FIGS. 1A and 1B). The electric solenoid 118 and palmbutton switch 123 can be electrically coupled by wiring 124. The wiring 124 can be routed internally, through the structure of the lift and carrier assembly 11 and under the platform 20, as shown in FIG. 1A. Alternatively, the wiring 124 can be routed externally to the lift and carrier assembly 11 and over the platform 20, as shown in FIG. 1B (routing the wiring 124 in this manner may be necessary in applications where the device 10 is installed after the lift and carrier assembly 11 has been assembled.)

Alternative embodiments of the device 10 can be equipped with a hand or foot-actuated switch mounted at a suitable location on the platform 20. The electric solenoid 118 can be activated using wireless means such as infrared or radio-frequency communications in other alternative embodiments.

The first pawl 112 includes a first edge portion 112a, and an adjoining second edge portion 112b (see FIG. 16). The shape of the second edge portion 112b substantially matches that of the fourth edge portion 30d of the first docking lever 30. The first and second edge portions 112a, 112b form an indentation 132 in the first pawl 112.

The first pawl 112 also includes a substantially straight third edge portion 112c, and a curved fourth edge portion 112d that adjoins the third edge portion 112c. The first pawl 112 further includes a fifth edge portion 112e that adjoins the fourth edge portion 112d.

The second pawl 114 is substantially identical to the first pawl 112. The second pawl 114 includes first, second, third, fourth, and fifth edge portions 114a, 114b, 114c, 114d, 114e that are substantially identical to the first, second, third, fourth, and fifth edge portions 112a, 112b, 112c, 112d, 112e of the first pawl 112.

The device 10 can further include a conventional limit switch 125, and an indicator light 126 (see FIGS. 1A, 1B, 3A, and 3B). The indicator light 126 can be mounted at a suitable location on the lift and carrier assembly 11, such as that shown in FIGS. 1A and 1B. The limit switch 125 can be fixedly coupled to the second side panel 28a of the yoke bracket 28 by way of a bracket 126. The limit switch 125 is positioned so that the fourth surface 114d of the second pawl 114 contacts and depresses an actuator 125a of the limit switch 125 when the second pawl 114 is in its engaged position (see FIG. 3A).

The limit switch 125 generates an output when the actuator 125a is depressed. The limit switch 125 is electrically coupled to the indicator light 126 so that the output of the limit switch 125 causes the indicator light 126 to illuminate. The indicator light 126 can thus provide the user with an indication that the second pawl 114 is in its engaged position.

The device 10 also comprises a mounting bracket 100 (see FIGS. 1A, 1B, and 4; the mounting bracket 100 is not shown in FIGS. 2A-2E, 3A, and 3B, for clarity). The mounting bracket 100 has a bottom panel 101, and first and second side panels 102, 103 that extend upward from opposing sides of the bottom panel 101. The bottom panel 101 is fixedly coupled to the bottom panel 28c of the yoke arm 28 by a suitable means such as fasteners, rivets, etc.

The mounting bracket 100 and the yoke arm 28 can be secured to a mounting plate 20a of the platform 20, as shown in FIGS. 1A, 1B, and 4). In particular, a plurality of through holes 105 are formed in the bottom panel 28c of the yoke arm 28 and the bottom panel 101 of the mounting bracket 100.

The mounting plate 20a has a plurality of through holes 106 formed therein. The through holes 106 can be formed along a substantial entirety of the length of the mounting plate 20a. The mounting bracket 101 and the yoke arm 28 can be positioned at a desired position on the mounting plate 20a, and the through holes 105 can be aligned with a corresponding set of the through holes 106. Conventional fasteners can be inserted through the through holes 105, 106 to secure the mounting bracket 101 and the yoke arm 28 to the mounting plate 20a.

Forming the through holes 106 along the length of the mounting plate 20a permits the yoke bracket 28 to be mounted at various positions on the platform 20 to accommodate a particular type of personal-transport vehicle, such as the power chair 14. Moreover, the height of the yoke bracket 28 in relation to the platform 20 can be adjusted by placing spacers between the bottom panel 101 of the mounting bracket 100 and the bottom panel 28c of the yoke bracket 28. These features can allow the device 10 to be used in conjunction with personal-transport vehicles of various types and sizes.

It should be noted that none of the various components of the receptacle 18 extend below the platform 20 (or other mounting surface). This feature can facilitate mounting the device 10 on surfaces such as the floorboard of a transporting vehicle.

The device 10 has been depicted as being mounted on the platform 20 for exemplary purposes only. The device 10 can be mounted on surfaces such as the bottom surface of a trunk of a passenger car, the floorboard inside a van or mini-van, the bed of a pickup truck, etc. The device 10 can be also be mounted on the floorboard of a motor vehicle, proximate the driver's position, so that a personal transport vehicle can be secured in a position that permits the occupant thereof to operate the motor vehicle.

The first side panel 102 of the mounting bracket 100 covers the first docking arm 30, first trigger 33, first pawl 112, and electric solenoid 118 when the yoke arm 28 is mounted on the mounting bracket 100. The second side panel 103 likewise covers the second docking arm 32, second trigger 34, second pawl 114, and limit switch 125 when the yoke arm 28 is mounted on the mounting bracket 100. The first and second side panels 102, 103 can thus protect the noted components from impact-related (and other types of) damage.

The plow bracket 16 can be fixedly coupled to the power chair 14 (or other personal-transport vehicle), as discussed above (see FIGS. 7, 8, and 10). The plow bracket 16 comprises a trunnion bracket 72 and a first and second trunnion 74, 76 (see FIGS. 5, 6, and 8). The trunnion bracket 72 comprises a substantially flat mounting portion 72a, a first lip 72b that extends downwardly from the mounting portion 72a, and a second lip 72c that extends downwardly from an opposing side of the mounting portion 72a. The trunnion bracket 72 preferably has a width that permits the trunnion bracket 72 to fit within the yoke arm 28 with minimal clearance between the first lip 72b and the first side panel 28a, and between the second lip 72c and the second side panel 28b.

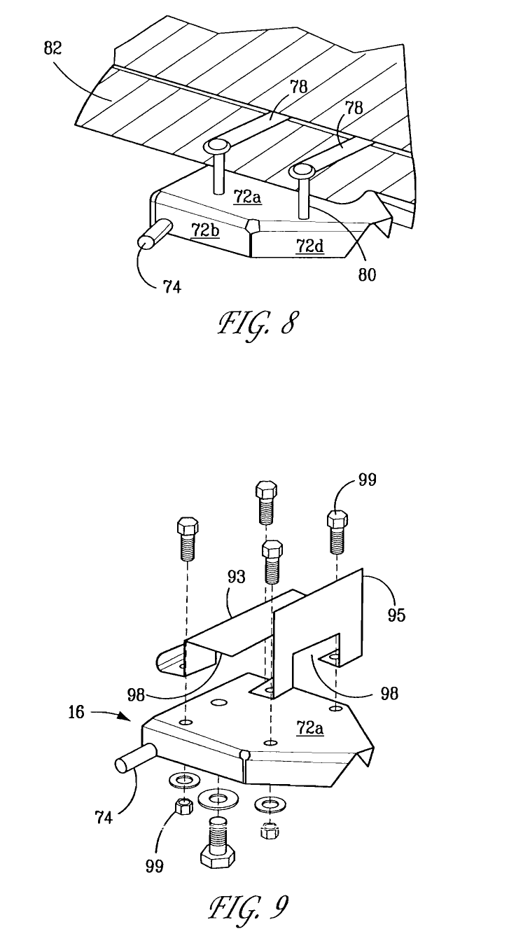

The first trunnion 74 is fixedly coupled to the lip 72b, and extends from the lip 72b as shown in FIG. 6. The second trunnion 76 is fixedly coupled to the lip 72c, and extends from the lip 72c.

The plow bracket 16 also comprises a third and a fourth lip 72d, 72e that each extend downwardly from the mounting portion 76a, forward of the first and second lips 72a, 72b. The lips 76d, 76e are angled with respect to a centerline C1 of the plow bracket 16 so that the width of the plow bracket 16 reaches a minimum at a forward edge 16a of the plow bracket 16. The significance of this feature is explained below.

The plow bracket 16 can secured to the power chair 14 in any suitable manner. For example, the plow bracket 16 can be secured to the power chair 14 by brackets 78 (see FIGS. 6 and 8). More particularly, the mounting portion 72a can be positioned against a bottom surface of a beam 82 or other structural member that is located on the underside of the power chair 14. The brackets 78 can be positioned above the beam 82 so that each bracket 78 straddles the beam 82. The brackets 78 can be secured to the mounting portion 72a by elongated bolts 80. The bolts 80 are accommodated by through holes 84 formed in opposing ends of each bracket 78, and by through holes 86 formed in the mounting portion 72a. The beam 82 is thus clamped between the brackets 78 and the mounting portion 72a, thereby securing the plow bracket 16 to the power chair 14.

Alternatively, the plow bracket 16 can be secured to the power chair 14 as follows using a first and a second bracket 95, 93 (see FIG. 9). The mounting portion 72a of the plow bracket 16 is positioned against the bottom surface of a beam 82. The brackets 95, 93 are subsequently placed over the beam 82 so that the brackets 95, 93 straddle the beam 82, and the beam 82 passes through a rectangular opening 98 defined in each of the brackets 95, 93. The brackets 95, 93 are then secured to the mounting portion 72a using fasteners 99, thereby securing the plow bracket 16 to the power chair 14. Other alternative mounting configurations for the plow bracket 16 are possible, depending on the configuration of the particular personal-transport vehicle with which the device 10 is used.

It should be noted that particular mounting configurations for the plow bracket 16 has been described for exemplary purposes only. Other mounting configurations can be used in the alternative.

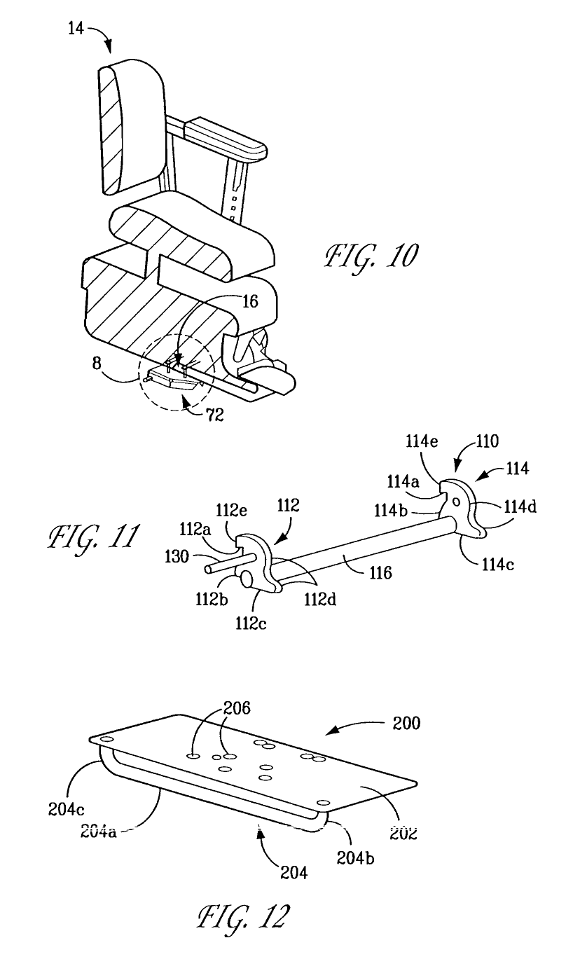

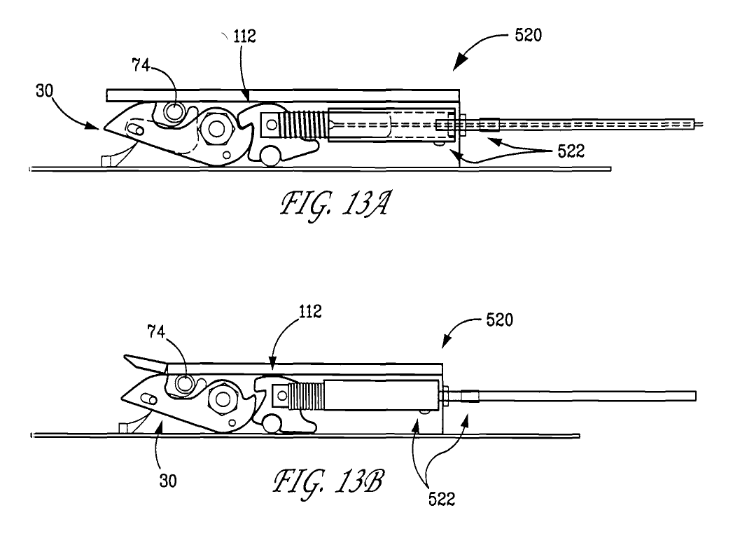

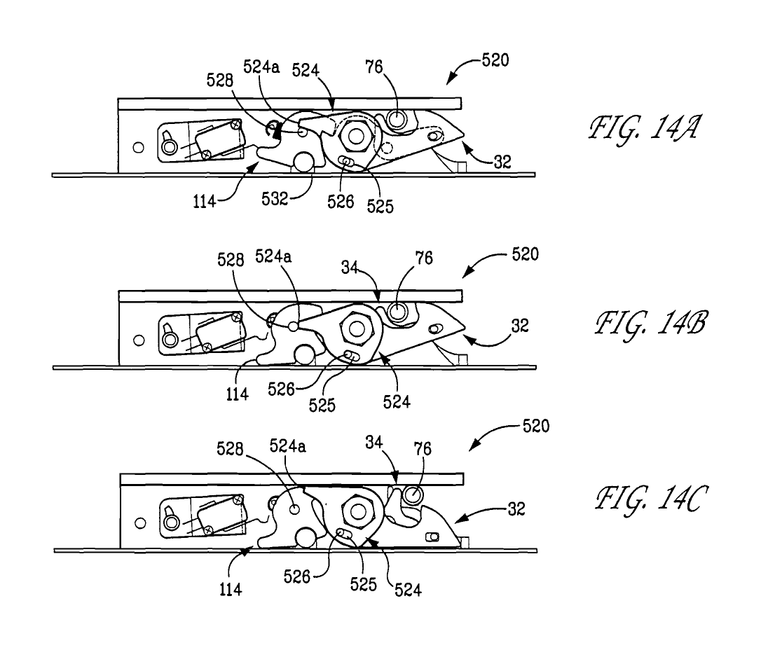

FIG. 12 depicts an alternative embodiment of the plow bracket 16. In, particular, FIG. 12 depicts a bracket member 200 comprising a plate 202, and a substantially U-shaped bar 204. The bar 204 has a substantially horizontal first portion 204a, and second and third portions 204b, 204c that adjoin opposite ends of the first portion 204a. The second and third portions 204b, 204c are secured to the plate 202 by a suitable means such as conventional fasteners. The bracket member 200 can be secured to a bottom surface of the power chair 14 by conventional fasteners inserted in through holes 206 formed in the plate 202.

The device 10 secures the power chair 14 to the platform 20 through engagement of the receptacle 18 and the plow bracket 16 (or the bracket member 200). More specifically, the receptacle 18 is positioned on the platform 20 so that the yoke arm 28 and the docking levers 30, 32 can securely engage the first and second trunnions 74, 76 (or the bar 204 of the bracket member 200) when the power chair 14 is driven fully onto the platform 20. Details relating to these features are as follows.

The first and second docking levers 30, 32 are each biased toward their respective releasing positions, as noted previously. The power chair 14 can be driven onto the platform 20 in a direction denoted by the arrow 210 shown in FIGS. 1A, 1B, 2D, and 3B (this direction is hereinafter referred to as the “forward” direction, and the opposing direction is referred to as the “rearward” direction).

The first and second docking levers 30, 32, the first and second triggers 33, 34, and the first and second pawls 112, 113 are in the respective positions depicted in FIGS. 2D and 3B when the device 10 is not engaging the plow bracket 16. In particular, the first and second docking levers 30, 32 are in their respective releasing positions, and the first and second triggers 33, 34 are in their respective second positions under this condition.

The solenoid 18 is preferably de-energized at the start of the docking process. The bias of the spring 119 urges the fifth edge portion 112e of the first pawl 112 against the fourth edge portion 30d of the first docking lever 30 under this condition (see FIG. 2D). The fifth edge portion 114e of the first pawl 114 is likewise urged against the fourth edge portion 32d of the second docking lever 32 in response to the bias of the spring 119 (see FIG. 3B) (the first and second pawls 112, 114 are therefore positioned proximate their respective disengaged positions the start of the docking process).

The plow bracket 16 is preferably positioned on the power chair 14 so that the first trunnion 74 substantially aligns with the first edge portion 33a of the first trigger 33, and the second trunnion 76 substantially aligns with the first edge portion 34a of the second trigger 34 as the plow bracket 16 approaches the receptacle 18 (see FIGS. 2D and 3B). (Interference between the third and fourth lips 72d, 72e of the plow bracket 16 and the respective first edge portion 28f of the first wing member 28d and first edge portion 28i of the second wing member 28e can help to align the plow bracket 16 and the receptacle 18 as the plow bracket 16 is mated with the receptacle 18. The angled orientation of the third and fourth lips 72d, 72e and the first edges portions 28f, 28i can further help to align the plow bracket 16 and the receptacle 18.)

Continued movement of the power chair 14 (and the plow bracket 16) in the forward direction causes the first trunnion 74 to contact the first edge portion 33a of the first trigger 33, and the second trunnion 76 to contact the first edge portion 34a of the second trigger 34 (see FIGS. 2C and 3B). Movement of the power chair 14 in the forward direction also causes the first and second trunnions 74, 76 to enter the respective slots 42, 43 in the respective first and second side panels 28a, 28b of the yoke bracket 28.

The noted contact between the first trunnion 74 and the first trigger 33 causes the first trigger 33 to rotate clockwise (from the perspective of FIGS. 2A-2E), toward its first position, as the power chair 14 continues to move in the forward direction. Contact between the second trunnion 76 and the second trigger 34 likewise causes the second trigger 34 to rotate counterclockwise (from the perspective of FIGS. 3A and 3B), toward its first position.

Movement of the first trigger 33 toward its first position exerts a torque on the first docking lever 30 by way of the second pin 97. This torque causes the first docking lever 30 to rotate in a clockwise direction (from the perspective of FIGS. 2A-2E), toward its locking position. Movement of the second trigger 34 toward its first position likewise exerts a torque on the second docking lever 32 that causes the second docking lever 32 to rotate toward its locking position.

The first and second trunnions 74, 76 become disposed within the respective indentations 52, 54 formed in the first and second docking levers 30, 32 as the first and second docking levers 30, 32 approach and reach their locking positions. Interference between the first and second trunnions 74, 76 and the respective edges 30b, 32b of the first and second docking levers 30, 32 prevents the trunnions 74, 76 from backing out of the respective slots 42, 43 in the yoke bracket 28. The noted interference thus prevents the plow bracket 16 from backing out of the receptacle 18, thereby securing the power chair 14 in position on the platform 20.

The bias of the spring 119 causes the first pawl 112 to rotate in a counterclockwise direction (from the perspective of FIG. 2A 2E), into its engaged position, as the first docking lever 30 reaches is locking position. (Rotation of the first docking lever 30 to its locking position eliminates the previously-noted interference between the fifth edge portion 112e of the first pawl 112 and the fourth edge portion 30d of the first docking lever 30, thereby facilitating clockwise rotation of the first pawl 112.)

The bias of the spring 119 likewise causes the second pawl 114 to rotate in a clockwise direction (from the perspective of FIGS. 3A and 3B), into its engaged position, as the second docking lever 30 reaches its locking position.

Rotation of the first pawl 112 to its engaged position causes the portion of the first pawl 112 defined by the first and fifth edge portions 112a, 112e to become disposed in the indentation 132 of the first docking lever 30. Moreover, the portion of the first docking lever 30 defined by the third and fourth edge portions 30c, 30d becomes disposed in the indention 56 of the first docking lever 30. The resulting interference between the first edge portion 112a of the first pawl 112 and the third edge portion 30c of the first docking lever 30 helps to secured to the first docking lever 30 in its locking position.

The indicator light 126 illuminates when the first and second pawls 112, 114 are in their respective engaged positions, as discussed above. The indicator light 126 can thus provide an indication that the first and second docking levers 30, 32 are secured in their respective locking positions. Moreover, coupling the first and second pawls 112, 114 by way of the shaft 116 prevents either of the first and second pawls 112, 114 from reaching its engaged position when the other of the first and second pawls 112, 114 does not simultaneously reach its respective engaged position. This feature can thus prevent incomplete locking of the first and second locking levers 30, 32. (Coupling the first and second pawls 112, 114 by way of the shaft 116 can also eliminate the need for a second of the solenoids 18 to actuate the first and second pawls 112, 114.)

The plow bracket 18 (and the power chair 14) can be released from the receptacle 18 as follows. The release process is initiated by activating the electric solenoid 118 via the palmbutton switch 123. Activation of the electric solenoid 118 causes the shaft 121 to be retracted into the body 120, against the bias of the spring 119.

Retraction of the shaft 121 imparts a torque to the first pawl 112 that causes the first pawl 112 to rotate in a clockwise direction (from the perspective of FIGS. 2A-2E), into its releasing position. (The torque exerted on the first pawl 112 is transmitted to the second pawl 114 by way of the shaft 116, and causes the second pawl 114 to simultaneously translate to its releasing position.)

The first and second trunnions 74, 76 remain in place within the slots 42, 43 of the respective first and second side panels 28a, 28b until the power chair 14 is moved in the rearward direction by the user. Moreover, the first and second triggers 33, 34 remain at or near their respective first positions due to contact with the respective first and second trunnions 74, 76 and the inertia of the power chair.

Movement of the power chair 14 in the rearward direction causes the first and second trunnions 74, 76 to back away from the respective first and second triggers 33, 34. The bias of the spring 60 causes the first docking lever 30 rotate in a counterclockwise direction (from the perspective of FIGS. 2A-2E), toward its releasing position, as the first trunnion 74 backs away from the first trigger 33. The first docking lever 30 drives the first trigger 33 in a counterclockwise direction, toward its second position, by way of the associated second pin 97.

The bias of the spring 62 likewise causes the first docking lever 30 toward its releasing position as the second first trunnion 76 backs away from the second trigger 34. The first docking lever 30 drives the first trigger 33 in a counterclockwise direction, toward its second position, by way of the associated second pin 97.

Further movement of the power chair 14 in the rearward direction eventually permits the first and second docking levers 30, 32 to reach their respective releasing positions, thereby allowing the first and second trunnions 74, 76 to completely back out of the respective slots 42, 43 (and permitting the power chair 14 to be driven off the platform 20.

The electric solenoid 118 preferably includes a timer 127 that deactivates the electric solenoid 118 after a predetermined operation, e.g., five to ten seconds (see FIG. 2A). Deactivation of the electric solenoid 118 permits the first and second pawls 112, 14 to return to the positions depicted respectively in FIGS. 2D and 3B after the power chair 14 has backed away from the receptacle 18. Alternatively, the first and second pawls 112, 113 can return to their engaged positions to secure the first and second docking levers 30, 32 in their respective locking positions if the power chair 14 has not backed away from the receptacle within the predetermined period.

The first pawl 112 can have a pin 130 secured thereto for manually actuating the first and second pawls 112, 114 between their respective engaged and disengaged positions (the pin 130 is shown only in FIGS. 1A, 1B, 4, and 11, for clarity). The pin 130 extends through a slot 131 formed the first side panel 102 of the mounting bracket 100. The pin 130 can be used to release the first and second docking levers 30, 32 from the respective first and second pawls 112, 114, for example, when electrical power to the electric solenoid 118 is not available, or when the electric solenoid 118 is otherwise non-functional.

Operation of the device 10 with the bracket member 200 is substantially similar to operation of the device 10 with the plow bracket 16. In particular, the first portion 204a of the bar 204 can contact and actuate the first and second triggers 33, 34 as the bracket member 200 is mated with the receptacle 18, in the manner described above in relation to the first and second trunnions 74, 76.

Moreover, interference between the second and third portions 204b, 204c of the bar 204 and the respective first edge portion 28f of the first wing member 28d and first edge portion 28i of the second wing member 28e can help to align the bracket member 200 and the receptacle 18 as the bracket member 200 is mated with the receptacle 18.

The power chair 14 (or other personal-transport vehicle) can thus be released from the platform 20 no action on the part of the user other than depressing the palmbutton switch 123 and driving (or otherwise moving) the power chair 14 off of the platform 20. Moreover, the receptacle 18 automatically returns to a configuration in which the receptacle 18 is ready to again receive the plow bracket 16.

The power chair 10 (or other type of personal-transport vehicle) can be maneuvered to engage the plow bracket 16 and the receptacle 18 by techniques other than driving the power chair. For example, the device 10 can be mounted on a floorboard of a van, and the power chair 14 can be lifted into the van using a conventional hoist-type lift, as discussed above. The power chair 14 can be maneuvered to engage the plow bracket 16 and the receptacle 18 by the lifting device in this type of mounting arrangement.

The engagement of the plow bracket 16 and the receptacle 18 can restrain the power chair 14 from rotational movement about an axis passing vertically through the platform 20, and about an axis passing through a centerline of the platform 20. The ability of the device 10 to restrain the power chair 14 from rotational movement represents a substantial advantage in relation to conventional power-chair restraints that inhibit linear motion only. For example, the added degree of restraint provided by the power chair 14 inhibits the power chair 18 from swiveling about the vertical axis as the transporting vehicle turns at relatively high speed, brakes suddenly, or bounces in response to rough road conditions. This added stability substantially reducers the potential for the power chair 14 to separate from the platform 20 as it is being transported.

Moreover, the device 10 can be adapted to various types of personal-transport vehicles. In particular, the device 10 can interface with a personal transport vehicle by way of a structural member located on the underside of the vehicle, e.g., the beam 82 of the power chair 14. Most personal-transport vehicles comprise a structural member suitable for this purpose. Moreover, the positions of the receptacle 18 and the plow bracket 16 can be adjusted in to accommodate personal-transport vehicles of difference sizes and configurations. Hence, the device 10 can be used in conjunction with personal-transport vehicles that range widely in size and general overall configuration.

The positions of the receptacle 18 and the plow bracket 16 can be adjusted without removing or otherwise altering the relationship between the first and the second docking levers 30, 32 and the yoke arm 28. In other words, the locking geometry of the device 10 remains constant regardless of the particular application in which the device 10 is used. Hence, a time-consuming readjustment of the locking geometry is not required each time the device 10 is used with a different type of personal-transport vehicle.

Devices that rely on a hold-down arm or similar mechanism, by contrast, are restricted to use with personal-transport vehicles having a suitable rigid surface within the range of motion of the hold-down arm. Certain types of personal-transport vehicles currently in widespread use, e.g., power chairs, are not commonly equipped with such a surface. Hence, the device 10 can be configured for use with a substantially greater variety of personal-transport vehicles than devices comprising a hold-down arm.

Moreover, the device is self-centering. In particular, the trunnions 74, 76 tend to straighten the power chair 14 with respect to the centerline of the platform 20 when the trunnions 74, 76 are driven forward into the slots 44, 46. Moreover, the trunnions 74, 76 and the first and second docking levers 30, 32 remain visible after the power chair 14 has been placed in its stored position on the platform 20. Hence, the latching mechanism 10 can provide a positive visual indication that the power chair 14 has been secured to the platform 20.

The foregoing description is provided for the purpose of explanation and is not to be construed as limiting the invention. Although the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, can make numerous modifications to the invention as described herein, and changes may be made without departing from the scope and spirit of the invention as defined by the appended claims.

For example, substantial variations can be made to the trunnion bracket 72 or the bracket member 200 to tailor the trunnion bracket 72 of the bracket member 200 to the configuration of a particular personal-transport vehicle with which the device 10 is used.

The orientations of the plow bracket 16 and the receptacle 18 in relation to the respective power chair 14 (or other personal-transport vehicle) and platform 20 (or other suitable mounting surface) can be reversed with respect to the orientations described above, to allow the plow bracket 16 to mate with the receptacle 18 when the power chair 14 is backed onto the platform 20.

Alternative embodiments of the plow bracket 16 can be mounted on the platform 20 (or other suitable mounting surface), and alternative embodiments of the receptacle 18 can be mounted on the power chair 14 (or other personal-transport vehicle). Moreover, alternative embodiments of the plow bracket 16 and the receptacle 18 can be mounted on the power chair 14 (or other personal-transport vehicle) and the platform 20 (or other suitable mounting surface) in a vertical orientation, i.e., in orientations rotated ninety degrees in relation to the above-disclosed orientations. With this arrangement, the power chair 14 can be positioned over the receptacle, and lowered so that the plow bracket engages the receptacle due to the downward movement of the plow bracket 16 in relation to the receptacle.

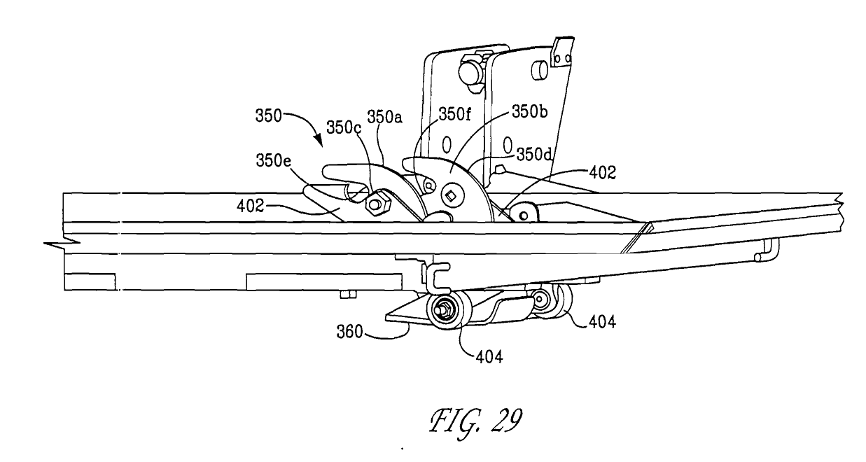

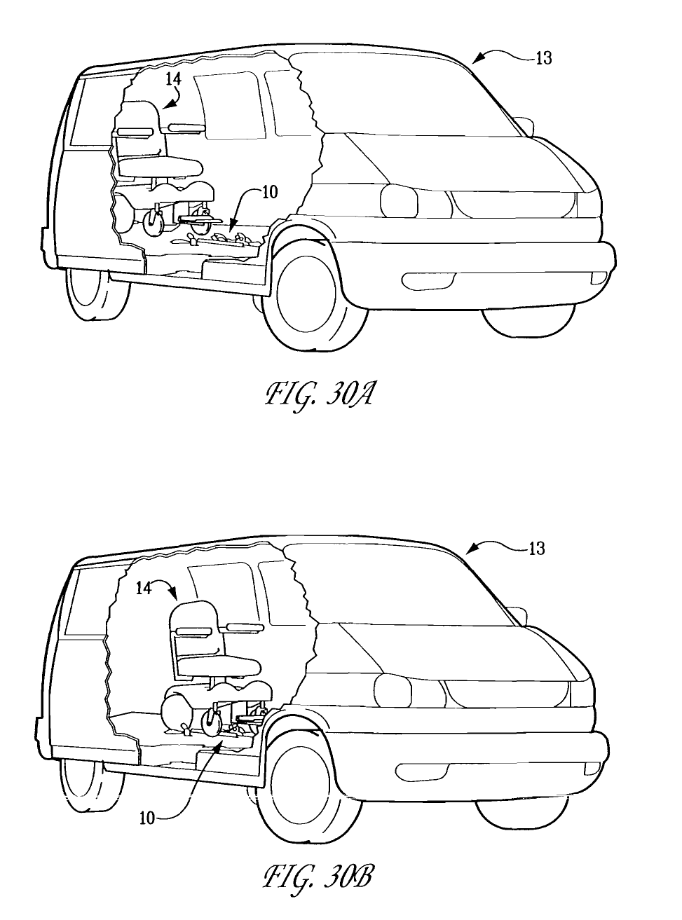

The alternative embodiment depicted in FIG. 29 also includes docking levers 402 actuated by contact between wheels 404 rotatably coupled thereto, and a ground or floor surface. A device of this type is also disclosed in application Ser. No. 10/126,791, now U.S. Pat. No. 6,837,666, which is incorporated by reference herein in its entirety.

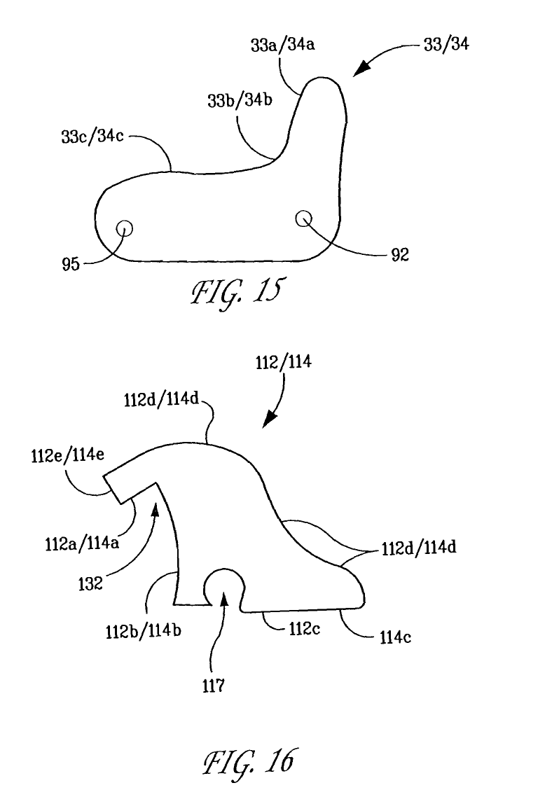

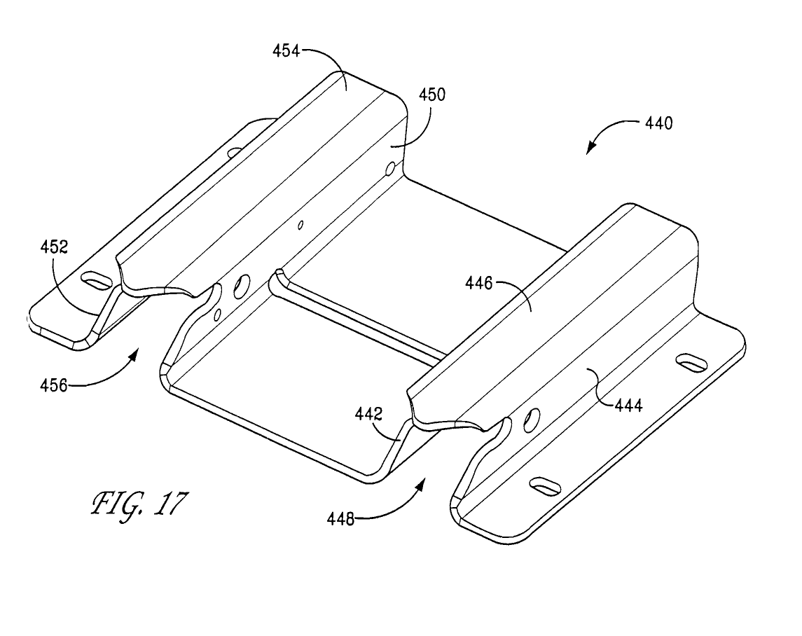

FIGS. 13A-14C depict an alternative embodiment of the device 10 in the form of a device 520. The device 520 is substantially identical to the device 10, with the exception that the first and second pawls 112, 114 are actuated by a manually-actuated cable mechanism 522 in lieu of the electric solenoid 118 (see FIGS. 13A and 13B). The cable mechanism 522 can be actuated by a suitable palm-actuated or foot-actuated lever.

The device 520 can be equipped with a toggle 524 to retain the first and second pawls 112, 114 in their respective disengaged positions until the plow bracket 16 is mated with the receptacle 18 (see FIGS. 14A-14C). In particular, the toggle 524 can be rotatably mounted on the threaded bolt 44 associated with the second side panel 28b. The toggle 524 has a slot 525 formed therein. A pin 526 mounted on the second docking lever 32 extends into the slot 525.

The toggle 524 rotates, due to its own weight, from the position depicted in FIG. 14A to the position depicted in FIG. 14B as the pawl 114 is moved from its engaged to its disengaged position. (Further counterclockwise movement of the toggle 524 past the position depicted in FIG. 14B is prevented by contact between the pin 526 and an end of the slot 524.) Contact between an edge 524a of the toggle 524 and a pin 528 mounted on the second pawl 114 causes the second pawl 114 (and the attached first pawl 112) to remain at or near their respective disengaged positions if pressure on the cable-actuator lever is released.

Movement of the second docking lever 32 to is releasing position causes the pin 525 to drive the toggle 524 in a clockwise direction (from the perspective of FIGS. 14A-14C), to the position depicted in FIG. 14C, thereby moving the edge 524a of the toggle 524 off of the pin 528. Hence, the second pawl 114 can subsequently move to its engaged position when the second docking lever 32 returns to its locking position.

FIG. 17 depicts an alternative embodiment of the yoke arm 28. In particular, FIG. 17 depicts a yoke arm 440. The yoke arm 440 comprises a first and a second side panel 442, 444, and a first top panel 446 that adjoins the first and second side panels 442, 444. The first and second side panels 442, 444 and the first top panel 446 define a channel 448 that houses the first docking lever 30, the first pawl 112, the first trigger 33, etc.

The yoke arm 440 further comprises a third and a fourth second side panel 450, 452, and a second top panel 454 that adjoins the third and fourth side panels 450, 452. The third and fourth side panels 450, 452 and the second top panel 454 define a channel 456 that houses the second docking lever 32, the second pawl 114, the second trigger 34, etc.

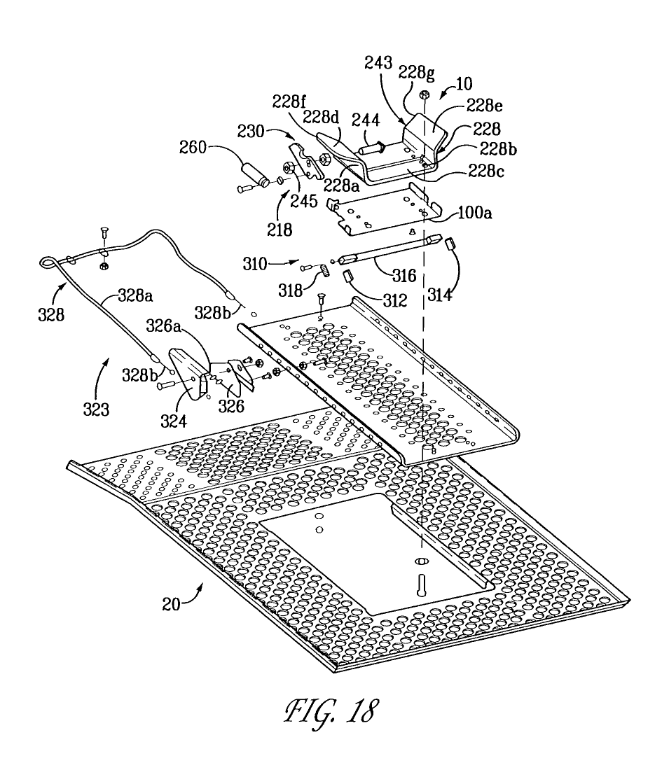

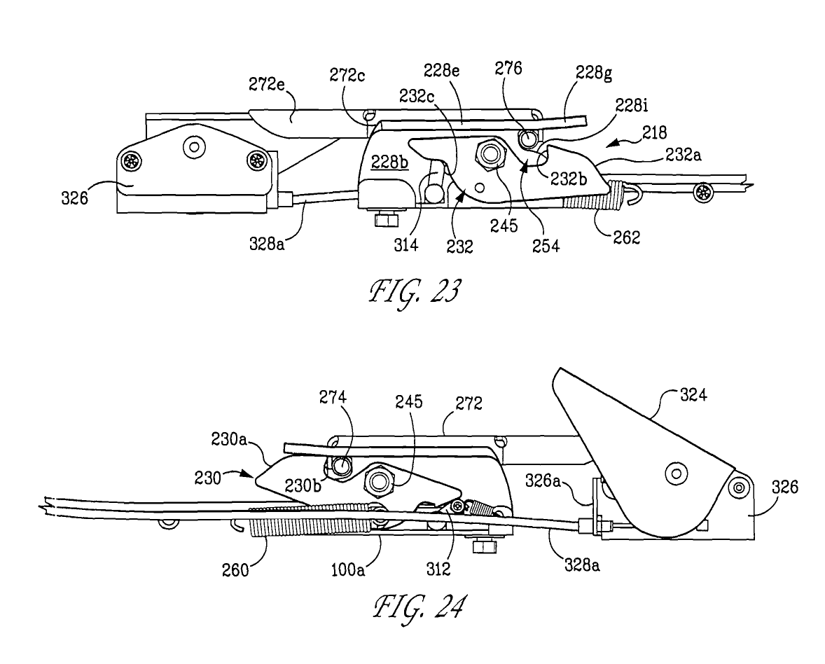

FIGS. 18-28 depict another alternative embodiment of the device 10. In particular, FIGS. 18-28 depict a device 208 comprising a plow bracket 216 and a receptacle 218. (The bracket member 200 can be used in lieu of the plow bracket 216, as discussed above in connection with the device 10.) The receptacle 218 comprises a yoke bracket 228, a first (or master) docking lever 230, and a second (or slave) docking lever 232 (see, e.g., FIGS. 18 and 23). The first and second docking levers 230, 232 are pivotally coupled to the yoke bracket 228, as explained in detail below.

The yoke bracket 228 comprises a first and a second side panel 228a, 228b, and a bottom panel 228c (see FIG. 18). The side panels 228a, 228b adjoin opposing ends the bottom panel 228c, and are substantially perpendicular to the bottom panel 228c.

The yoke bracket 228 also comprises a first and a second wing member 228d, 228e. The first and second wing members 228d, 228e adjoin the respective first and second side panels 228a, 228b.

The first wing member 228d comprises a tab portion 228f, and the second wing member 228e comprises a tab portion 228g (see FIG. 18). The tab portions 228f, 228g are each angled outwardly and upwardly (from the perspective of FIG. 18). (It should be noted that alternative embodiments of the yoke bracket 228 can be formed without the tab portions 228f, 228g.)

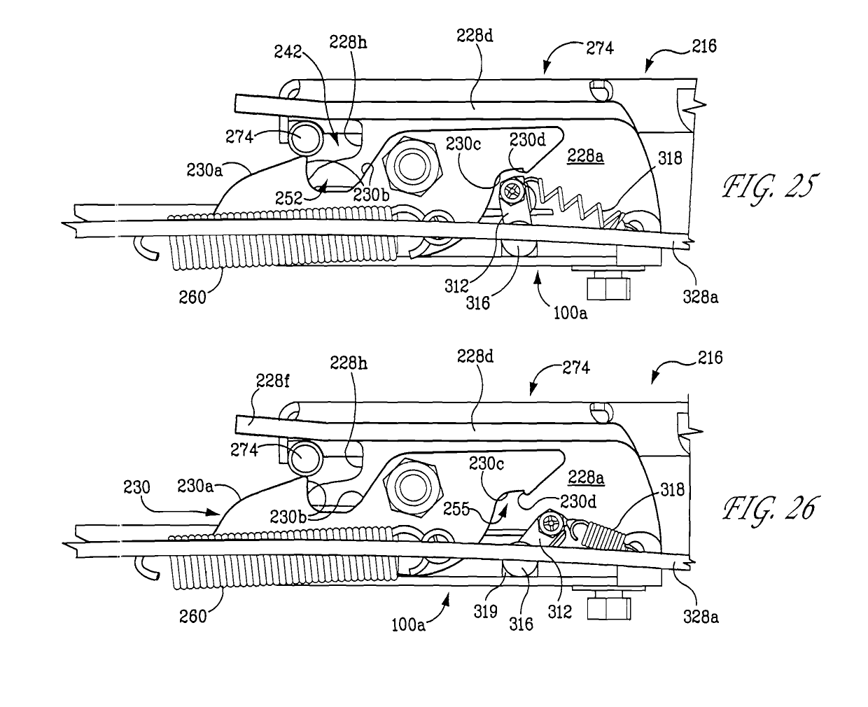

The first side panel 228a has a first edge portion 228h, and the second side panel 228b has a first edge portion 228i (see, e.g., FIGS. 22 and 23). The first edge portion 228h defines an open-ended slot 242 (see FIG. 25). The first edge portion 228i defines an open-ended slot 243 (see FIGS. 18 and 23).

The first and second docking levers 230, 232 are pivotally coupled to the yoke bracket 228, as previously-noted. More particularly, the first docking lever 230 is pivotally coupled to the side panel 228a by way of a threaded bolt 244 (see FIG. 18). The bolt 244 is accommodated within through holes formed in each of the side panel 228a and the docking lever 230, and is axially restrained by nuts 245 located on opposing sides of the docking lever 230. The second docking lever 232 is pivotally coupled to the side panel 228b by a second of the threaded bolts 244. The second bolt 244 is accommodated within through holes formed in each of the side panel 228b and the docking lever 232, and is axially restrained by a third and a fourth of the nuts 245, located on opposing sides of the docking lever 232.

The first and second docking levers 230, 232 can pivot between a locking position (see, e.g., FIG. 27) and a releasing position (see, e.g., FIGS. 25 and 26). The docking levers 230, 232 are pivotally biased in a clockwise direction (from the perspective of FIG. 22) by respective springs 260, 262 (see, e.g., FIGS. 15, 22, and 23). In other words, the springs 260, 262 bias the docking levers 230, 232 toward the locking position.

The first docking lever 230 has a first edge portion 230a, and a second edge portion 230b that adjoins the first edge portion 230a (see, e.g., FIG. 22). The second edge portion 230b defines a first indentation 252 in the first docking lever 230. The docking lever 232 has a first edge portion 232a, and a second edge portion 232b that adjoins the first edge portion 232a (see, e.g., FIG. 23). The second edge portion 232b defines a first indentation 254 in the second docking lever 232. The significance of these features is explained below.

The first docking lever 230 also has a third edge portion 230c, and an adjoining fourth edge portion 230d (see, e.g., FIG. 25). The third and fourth edge portions 230c, 230d define a second indentation 255 in the first docking lever 230. The second docking lever 232 has a third edge portion 232c (see FIG. 23).

The first and second docking levers 230, 232 are restrained from clockwise rotation past their respective locking positions by the tab portions 228f, 228g on the yoke bracket 228. More particularly, the tab portion 228f is located above the first edge 230a of the docking lever 230, and intersects the plane of rotation of the docking lever 230 (see, e.g., FIG. 27). Clockwise rotation of the docking lever 230 causes the first edge 230a to contact the tab portion 228f as the docking lever 230 reaches the locking position. This contact interferes with further clockwise movement of the docking lever 230, and thereby prevents the docking lever 230 from pivoting past its locking position.

The tab portion 228g is located above the first edge 232a of the docking lever 232, and intersects the plane of rotation of the docking lever 232 (see FIG. 23). Clockwise rotation of the docking lever 232 causes the first edge 232a to contact the tab portion 228g as the docking lever 232 reaches the locking position. This contact interferes with further clockwise movement of the docking lever 232, and thereby prevents the docking lever 232 from pivoting past its locking position.

The yoke bracket 228 can be mounted on the platform 20 using a mounting bracket 100a substantially similar to the mounting bracket 100.

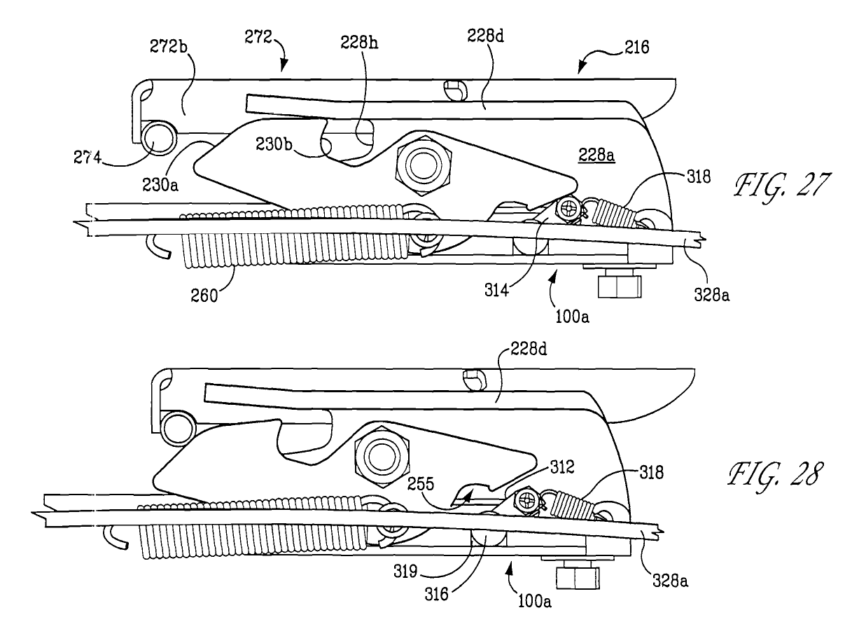

The device 208 also comprises a pawl assembly 310 (see, e.g., FIG. 18). The pawl assembly 310 comprises a first (or master) pawl 312, a second (or slave) pawl 314, a shaft 316, and a spring 318. The first and second side panels 228a, 228b each have a slot 319 formed therein for receiving the shaft 316 (see, e.g., FIGS. 26 and 28). The first pawl 312 is fixedly coupled to a first end of the shaft 316, outward of the first side panel 228a. The second pawl 314 is fixedly coupled to a second end of the shaft 316, outward of the second side panel 228b.

The shaft 316 can rotate within slots 319 formed in the first and second side panels 228a, 228b. This rotation permits the first and second pawls 312, 314 to each move between a first position (FIGS. 22-25) and a second position (FIGS. 26-28. The spring 318 biases the first pawl 314 in a clockwise direction (from the perspective of FIG. 22), toward its second position. (The spring 318 also biases the second pawl 314 toward its second position by way of the shaft 316.) The significance of these features is discussed below.

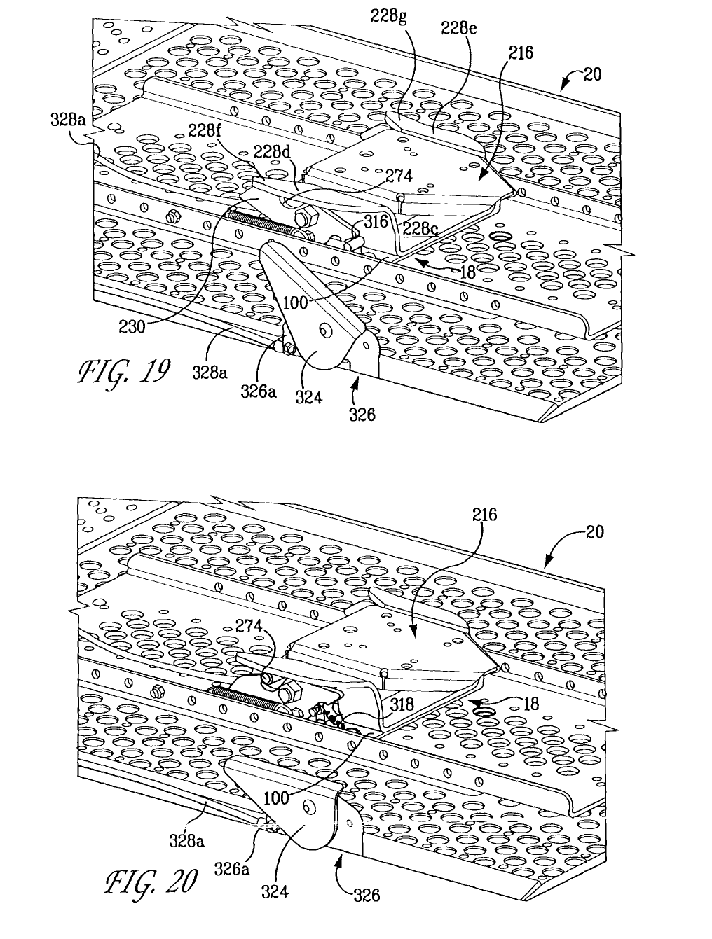

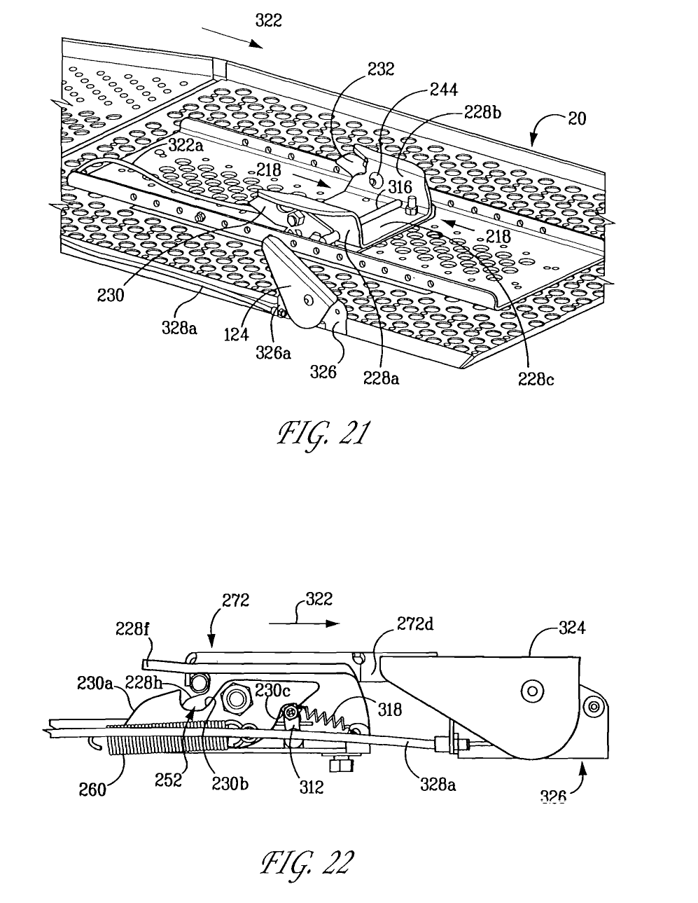

The device 208 also includes a release mechanism 323 (see, e.g., FIG. 18). The release mechanism 323 comprises a release lever 324, a bracket 326, and a cable such as a throttle cable 328. The throttle cable 328 comprises an outer jacket 328a, and a cable member 328b slidably disposed within the jacket 328a. The release lever 324 is pivotally coupled to the bracket 326. The release lever 324 can pivot between a first position (FIGS. 20 and 22) and a second position (FIGS. 19 and 21).

The bracket 326 can be fixedly coupled to a suitable mounting surface such as an edge the platform 20 (see FIGS. 19-21). The release lever 324, as explained below, can be depressed by the user to release the plow bracket 216 (and the power chair 14) from the receptacle 218. The bracket 326 and the release lever 324 can be mounted at a suitable location on the platform 20 or the transporting vehicle so as to allow the user to release the power chair 14 from a convenient position, without having to reach under the power chair 14. (The release mechanism 323 can thus function as a remotely-activated release.) The release lever 324 can take the form of a foot lever (as shown) or, for example, a palm pad.

A first end of the cable member 328b is fixedly coupled to the release lever 324. A first end of the jacket 328a is fixedly coupled to a flange 326a formed on the bracket 326 (see FIGS. 18 and 22). A second end of the cable member 328b is fixedly coupled to the first pawl 312.

The throttle cable 328 is preferably adjusted so that movement of the release lever 324 from its second to its first position moves the first pawl 312 from its second position to its first position. (The second pawl 314 moves from its second position to its first position along with the first pawl 312 due to the coupling of the first and second pawls 312, 314 by way of the shaft 316.)

The first and second docking levers 230, 232 are each biased toward their respective locking positions, as noted previously. The power chair 14 can be driven onto the platform 20 in a direction denoted by the arrow 322 in FIGS. 21 and 22 (this direction is hereinafter referred to as the “forward” direction, and the opposing direction is referred to as the “rearward” direction).

The plow bracket 216 is preferably positioned on the power chair 14 so that the first trunnion 274 substantially aligns with and contacts the first edge 230a of the first docking lever 230, and the second trunnion 276 substantially aligns with and contacts the first edge 232a of the second docking lever 232 as the power chair 14 advances in the forward direction.

Continued movement of the power chair 14 in the forward direction eventually causes the plow bracket 216 to mate with the receptacle 218. More particularly, movement of the power chair 14 in the forward direction causes the plow bracket 216 to become disposed within the yoke bracket 228, i.e., the forward edge of the plow bracket 216 enters the area between the side panels 228a, 228b of the yoke bracket 228 (see FIG. 27).

Further movement of the power chair 14 in the forward direction causes the first and second trunnions 274, 276 to ride along the respective first edges 230a, 232a of the first and second docking levers 230, 232 (see FIG. 25). The contact between the first and second trunnions 274, 276 and the respective first edges 230a, 232a forces (deflects) the first edges 230a, 232a downward (from the perspective of FIG. 25), and thereby causes the first and second docking levers 230, 232 to rotate in a counterclockwise direction.

Continued movement of the first and second trunnions 274, 276 along the respective first edges 230a, 232a eventually causes the first and second trunnions 274, 276 to reach the indentation 252, 254 in the first and second docking levers 230, 232. The first and second trunnions 274, 276 also enter the slots 242, 243 formed in the respective first and second side panels 228a, 228b of the yoke bracket 228.

The bias exerted on the first and second docking levers 230, 232 by the respective springs 260, 262 causes the first and second docking levers 230, 232 to rotate in a clockwise direction (from the perspective of FIG. 25) when the first and second trunnions 274, 276 reach the indentations 252, 254 formed in the respective first and second docking levers 230, 232. In other words, the first and second docking levers 230, 232 rotate back toward their respective locking positions when the first and second trunnions 274, 276 reach the respective indentations 252, 254.

Rotation of the first and second docking levers 230, 232 causes the first and second trunnions 274, 276 to become positioned within the respective indentations 252, 254 (see FIG. 25). (It should be noted that the first and second docking levers 230, 232 can rotate independently of each other.) The plow bracket 216 and the receptacle 218 can thus be mated with no action on the part of the user other than driving the power chair 14 (or other personal transport vehicle) onto the platform 20 so that the plow bracket 216 engages the receptacle 218 in the above-noted manner.

Interference between the first trunnion 274, the second edge portion 230b of the first docking lever 230, and the first edge portion 228h of the first side panel 228a can retain the first trunnion 274 within the indentation 252 and the slot 242. More particularly, the first and second edge portions 230a, 230b of the first docking lever 230 form a hook-like structure. This structure, in conjunction with the bias of the spring 260, can inhibit movement of the first trunnion 274 in the rearward direction. Movement of the first trunnion 274 in the forward direction is inhibited by the first edge portion 228h of the bracket 228.

Interference between the second trunnion 276, the second edge portion 232b of the second docking lever 232, and the first edge portion 228i of the yoke bracket 228 can retain the second trunnion 276 within the indentation 254 and the slot 243. More particularly, the first and second edge portions 232a, 232b of the second docking lever 232 form a hook-like structure. This structure, in conjunction with the bias of the spring 262, can inhibit movement of the second trunnion 276 in the rearward direction. Movement of the second trunnion 276 in the forward direction is inhibited by the first edge portion 228i of the bracket 228.

The plow bracket 218 (and the power chair 14) can be released from the receptacle 218 by the release mechanism 323 and the pawl assembly 310. In particular, movement of release lever 324 from its second to its first position causes the first and second pawls 312, 314 to move from their respective second positions to their respective first positions (see FIGS. 22 and 23).

Movement of the first pawl 312 from its second to its first position causes a portion of the first pawl 312 to enter the second indentation 255 formed in the first docking lever 230, as shown in FIG. 22. In particular, the first pawl 312 contacts the third and fourth edge portions 230c, 230d of the first docking lever 230 when the first pawl 312 is in its first position. Contact between the substantially straight fourth edge portion 230d and the first pawl 312 can help to restrain the first pawl 312 in its first position when pressure on the release lever 324 is lessened or eliminated. In other words, the first docking lever 230 can “capture” the first pawl 312 in the second indentation 255, and can thereby inhibit the pawl 312 from returning to its second position in response to the bias of the spring 318.

It should be noted that the second docking lever 232 does not include an edge portion such as the fourth edge portion 230d. The second docking lever 232 therefore does not restrain the second pawl 314 in manner similar to the first docking lever 230 and the first pawl 312.

The first and second trunnions 274, 276 cannot clear the respective second edge portions 230b, 232b when the first and second docking levers 230, 232 are positioned as depicted in FIGS. 22 and 23. The curved surfaces of the first and second trunnions 274, 276, however, permit the respective second edge portions 230b, 232b to ride along (and under) the trunnions 274, 276 as the power chair 14 is backed off of the platform 20, i.e., as the power chair 14 is moved in the rearward direction (after the first pawl 312 has been locked in is first position). This contact drives the first docking lever 230 further in the counterclockwise direction, to the position depicted in FIG. 26. (The second docking lever 232 is likewise driven to a similar position not shown in the figures.) The additional rotation of the first and second docking levers 230, 232 permits the trunnions 274, 276 to clear the respective second edge portions 230b, 232b.

The rotation of the first docking lever 230 to the position depicted in FIG. 25 also releases the first pawl 312 from the first docking lever 230, thereby allowing the first and second pawls 312, 314 to return to their respective second positions in response to the bias of the spring 318.

Further movement of the power chair 14 in the rearward direction causes the first and second trunnions 274, 276 to back completely out of the respective indentations 254, 256 and the respective slots 242, 243, thereby releasing the plow bracket 216 (and the power chair 14) from the receptacle 218.

The first and second docking levers 230, 232 return to their respective locking positions due to the bias of the respective springs 260, 262 (and because the first and second pawls 312, 314 have returned to their respective second positions, as described above) as the first and second trunnions 274, 276 back away from the first and second docking levers 230, 232.

The power chair 14 (or other personal-transport vehicle) can thus be released from the platform 20 no action on the part of the user other than actuating the release lever 324 and driving (or otherwise moving) the power chair 14 off of the platform 20. Moreover, the receptacle 218 automatically returns to a configuration in which the receptacle 218 is ready to again receive the plow bracket 216.

It should be noted that the first and second docking levers 230, 232 are spring biased in their respective closed positions when the plow bracket 216 is mated with the receptacle 218. This feature can minimize the potential for injuries caused by inadvertently placing a finger, hand, foot, etc. in or near the receptacle 218 when the power chair 14 is not secured thereto. In other words, the preferred design of the device 208 makes it unlikely that the first and second docking levers 230, 232 will snap shut on a finger, toe, etc. that comes into contact with the receptacle 218.

Alternative embodiments of the releasing mechanism 323 can include an electric motor or solenoid, such as the electric solenoid 118, for moving the first and second pawls 312, 314 between their respective first and second positions.

FIG. 29 depicts an alternative embodiment of the yoke bracket 228. In particular, FIG. 17 depicts a hook-type yoke bracket 350 that can be used in lieu of the yoke bracket 228 in the device 208 (or other device). The yoke bracket 350 is substantially similar to the yoke bracket 228, with the exception that a first and a second side panel 350a, 350b of the yoke bracket 350 do not have wing members, such as the first and second wing member 228d, 228e, installed thereon. Moreover, the first side panel 350a has a rounded first (upper) edge portion 350c, and the second side panel 350b has a rounded first (upper) edge portion 350d.

The first side panel 350a has a second (forward) edge portion 350e that is substantially similar to the first edge portion 228h of the first side panel 228a. The second side panel 350b has a second (forward) edge portion 350f that is substantially similar to the first edge portion 228i of the second side panel 228b.

The yoke bracket 228 has a lower vertical profile than the yoke bracket 350 due to the use of the first and second wing member 228d, 228e thereon. The yoke bracket 228 can therefore be used with personal-transport vehicles having relatively low ground clearance, i.e., with personal transport vehicles whose ground clearance may be insufficient to clear the yoke bracket 350 when the personal-transport vehicle is driven onto the ramp 20.

The alternative embodiment depicted in FIG. 29 also includes docking levers 402 actuated by contact between wheels 404 rotatably coupled thereto, and a ground or floor surface. A device of this type is also disclosed in U.S. Pat. No. 6,837,666, the contents of which is incorporated by reference herein in its entirety.

A skid plate 360 is mechanically coupled to the docking levers 202, and can be used to increase the contact area with the ground or floor surface. This feature can be particularly valuable when the ground or floor surface is gravel, stone, sand, or other material that may not provide a sufficient reacting force when the relatively small wheels 204 come into contact therewith.

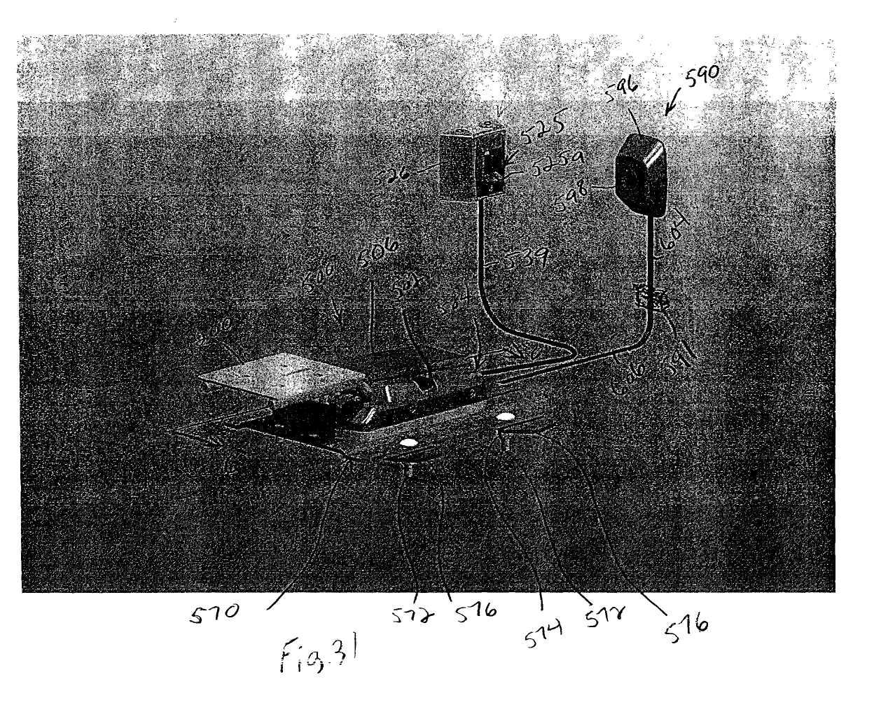

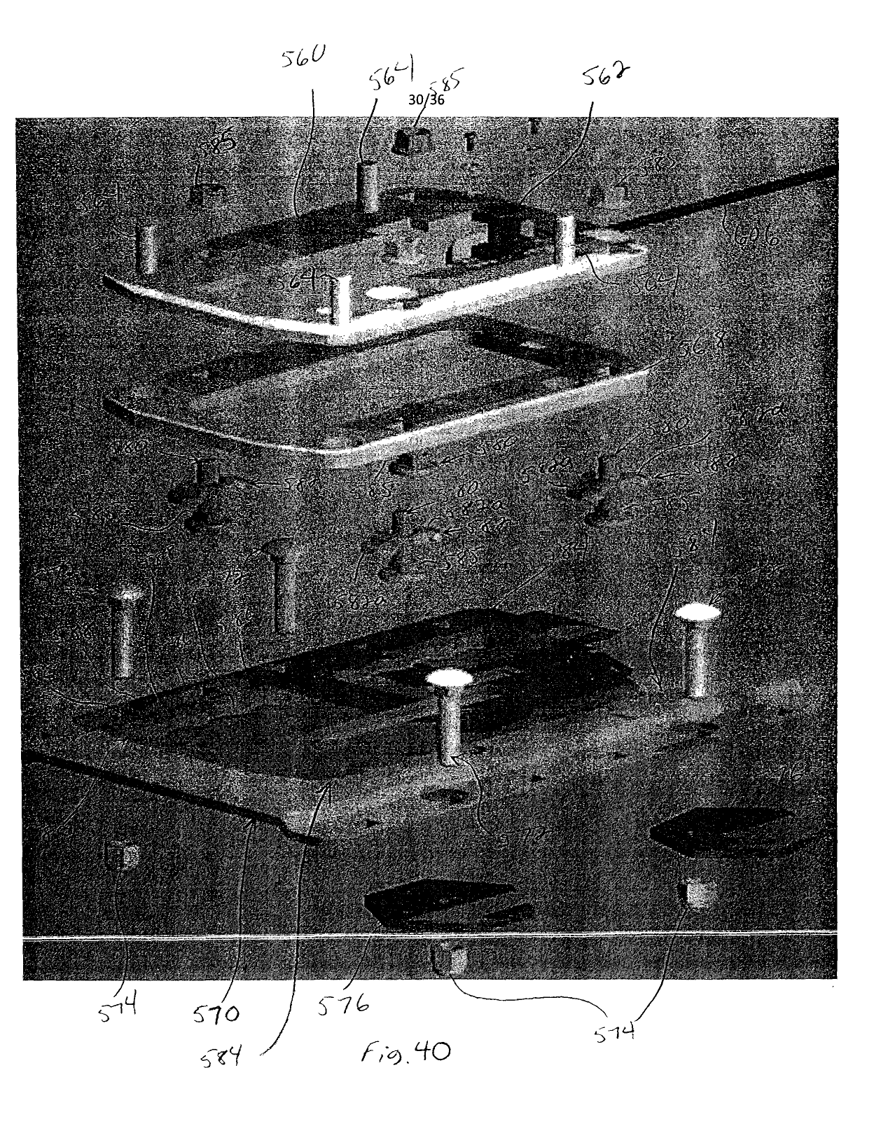

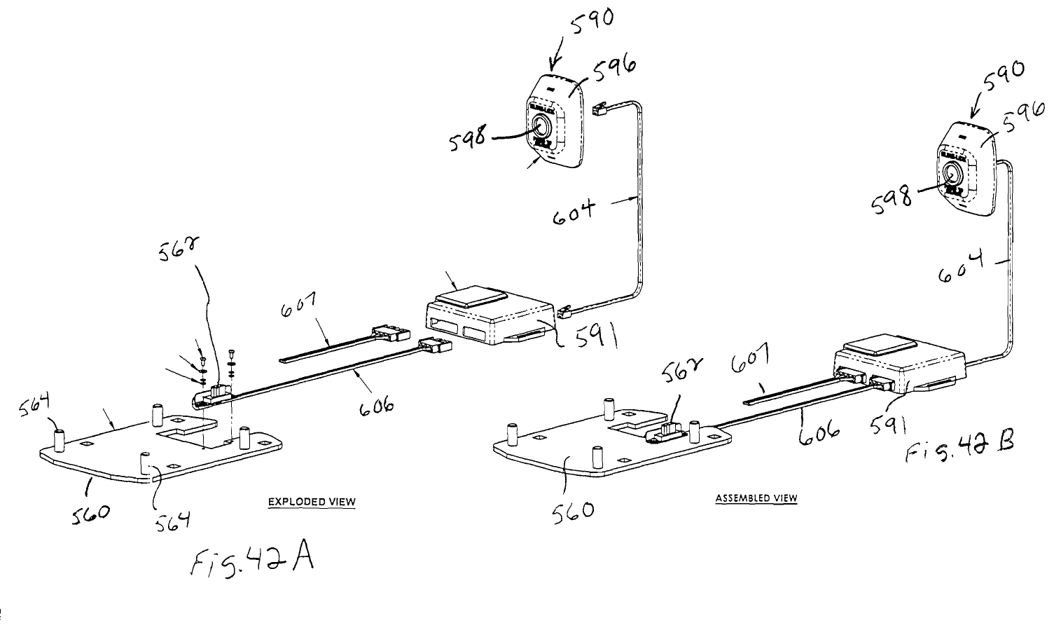

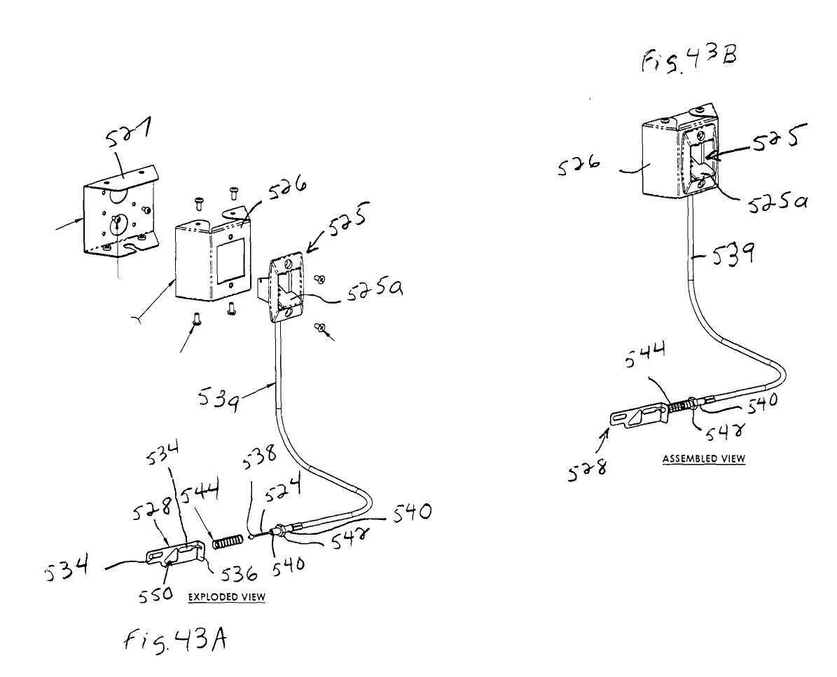

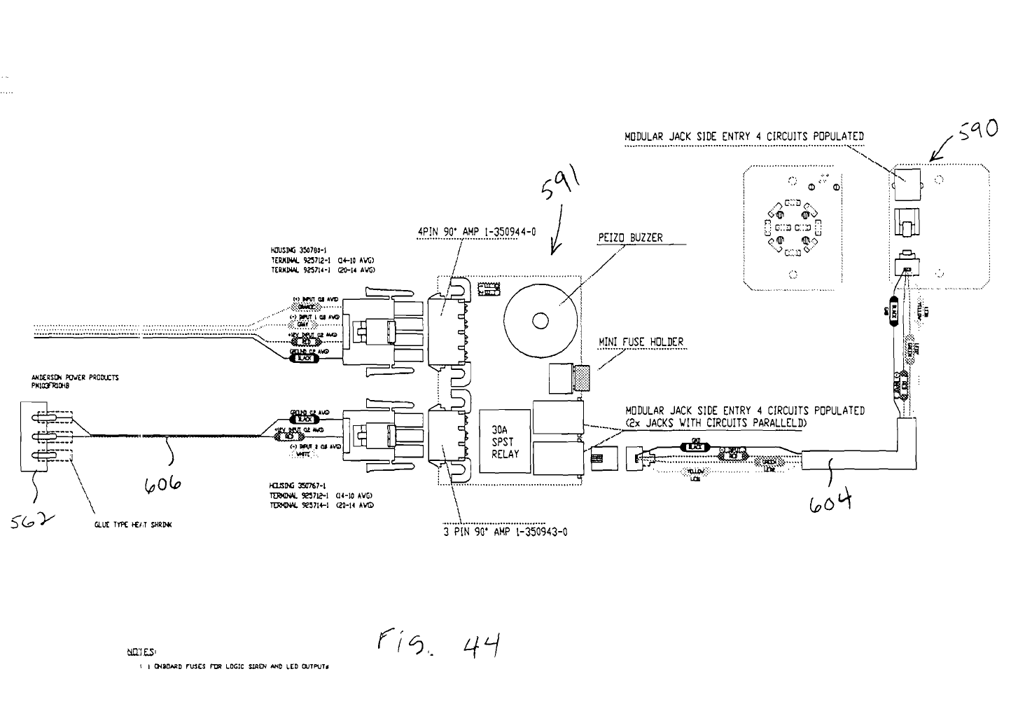

FIGS. 31-46F depict an alternative embodiment of the device 10 in the form of a device 500. The principles of operation described above in relation to the device 10 also apply to the device 500, unless otherwise noted.

The device 500 includes provisions to manually release a bracket member such as the bracket member 200. The device 500 can also be used in conjunction with a plow bracket such as the plow bracket 16. In particular, the device 500 includes two pushbuttons 502 each mounted on a respective bezel 504 of the device 500. The bezels 504 are secured to a yoke bracket 506 of the device 500 by a suitable means such as screws or other types of fasteners.

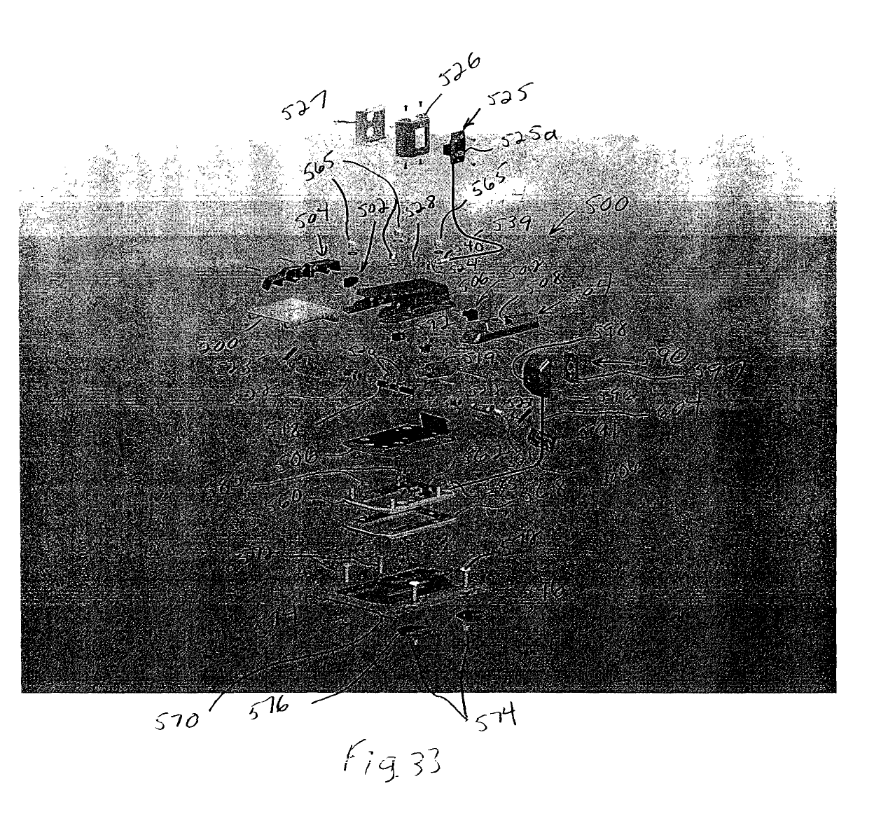

Each bezel 504 has a slot 508 incorporated therein to accommodate the associated pushbutton 502, as shown in FIGS. 32 and 35. Each pushbutton 502 can move upwardly and downwardly within its associated slot 508, from the perspective of FIG. 32. Each slot 508 is defined, in part, by two vertically-oriented ribs 509 of the associated bezel 504.

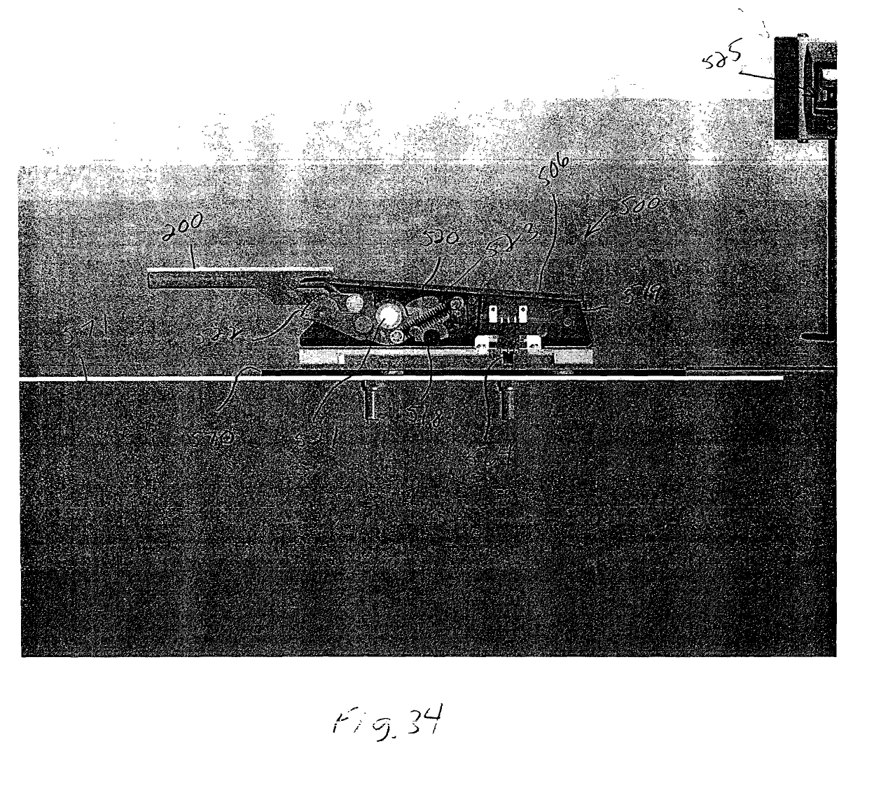

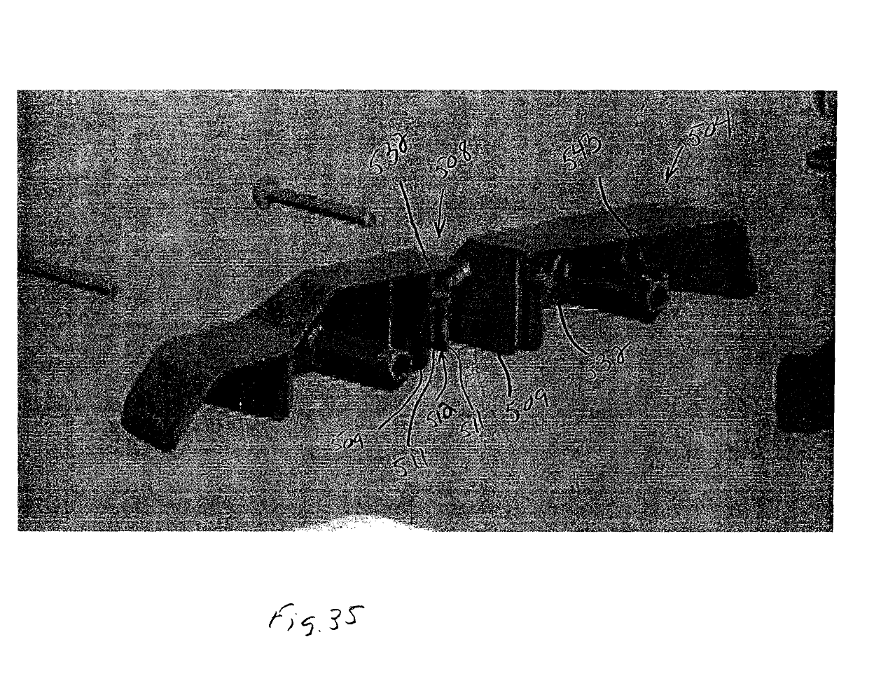

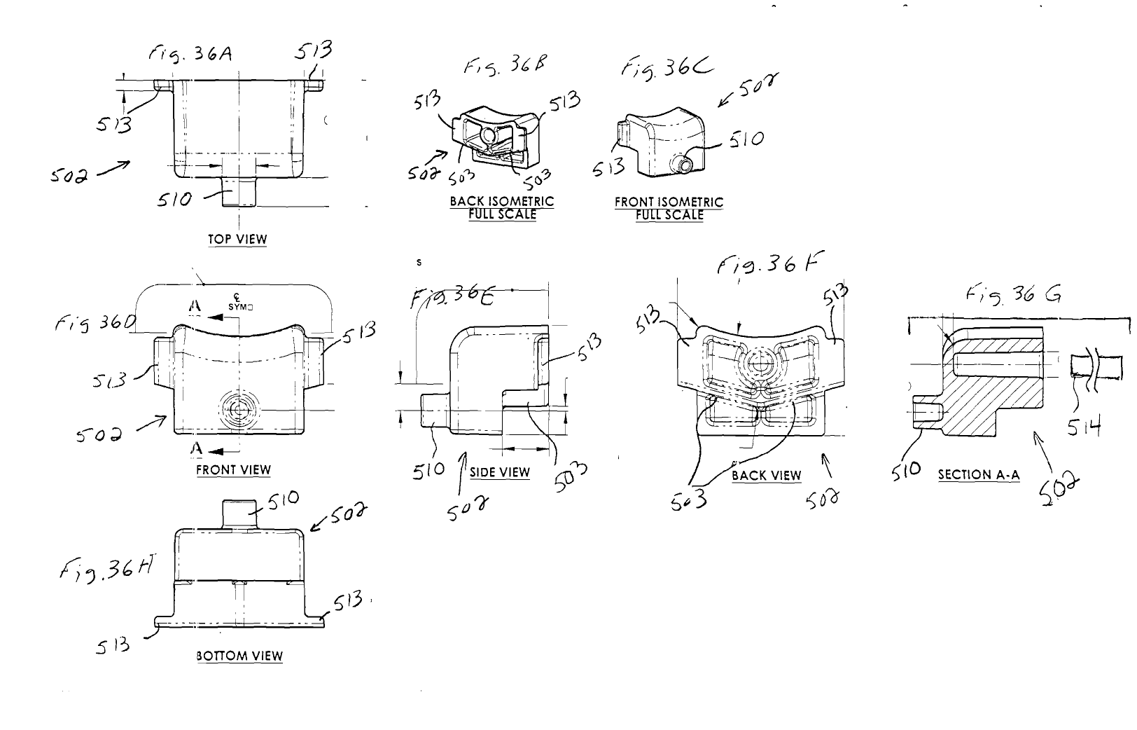

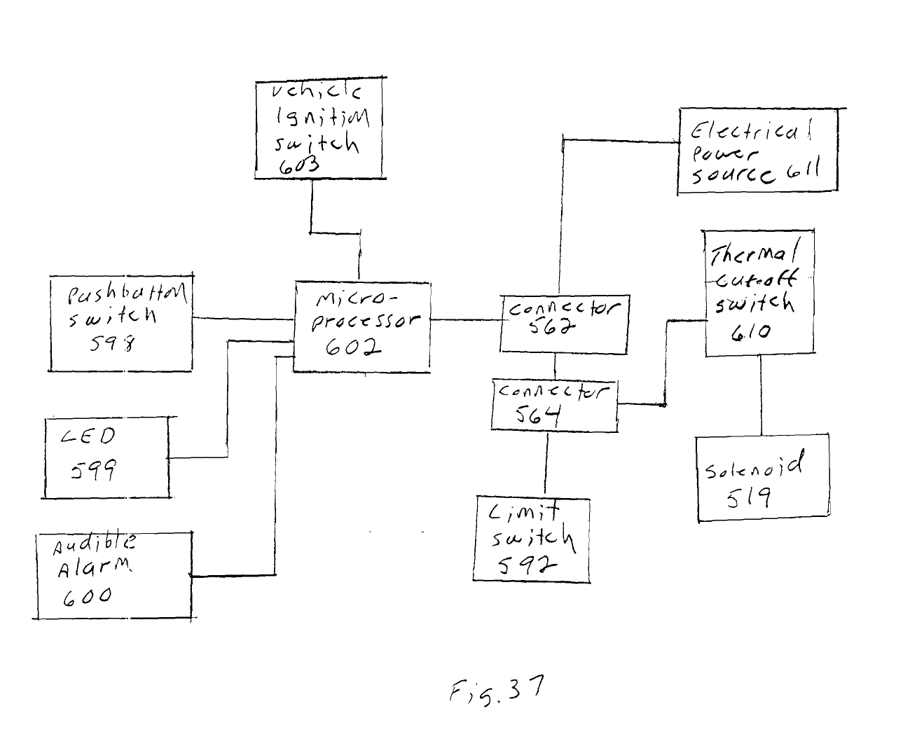

The pushbuttons 502 each include a projection 510, as shown in FIGS. 36A-36H. The bezels 504 each include two ribs 511 that define a groove 512, as shown in FIG. 35. Each groove 512 receives the projection 510 of the associated pushbutton 502. Each pushbutton 502 also includes two tabs 513 positioned on opposite sides of the pushbutton 502, as shown in FIGS. 36A-36F and 36H. Each tab 513 rides against an associated rib 509 as the pushbutton 502 translates upwardly and downwardly. The ribs 509, 511 help to guide the associated pushbutton 502 in the upward and downward directions.

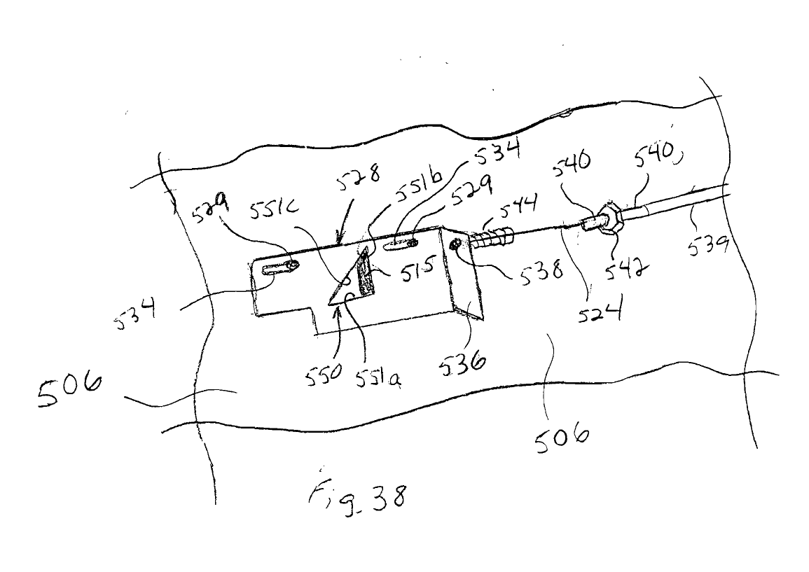

A pin 514 is mounted on each pushbutton 502. Each pin 514 projects inwardly from its associated pushbutton 502 into an associated slot 515 formed in the yoke bracket 506. The pin 514 and the slot 515 are depicted in FIGS. 36G and 38, respectively.

The device 500 further includes two pawls 520 mounted on a shaft 518, and a solenoid 519, as shown in FIGS. 32, 33, 39, and 41. The shaft 518 extends through the yoke bracket 506, and rotates in relation to the yoke bracket 506. The solenoid 519 is mechanically coupled to the pawls 520 so that actuation of the solenoid 519 causes the pawls 520 and the pawl shaft 518 to rotate about the centerline of the pawl shaft 518 in a clockwise direction, from the perspective of FIG. 34.

Two pins 516 are mounted on the shaft 518, as shown in FIGS. 39 and 41. The pins 516 are mounted proximate opposing ends of the shaft 518, and are located outside of the yoke bracket 506.

The device 500 also includes two docking levers 522 mounted on a shaft 521, as shown in FIGS. 39 and 41. The shaft 521 extends through the yoke bracket 506, and rotates in relation to the yoke bracket 506. The docking levers 522 move between a releasing position and a locking position in response to rotation of the shaft 521. The docking levers 522 are biased in the counterclockwise direction (from the perspective of FIG. 34), toward their releasing positions by springs 523.

The docking levers 522 are restrained in their respective locking positions by the pawls 520. In particular, one of the pawls 520 is depicted in FIG. 34 in an engaged position in which the pawl 520 contacts its associated docking lever 522, and prevents rotation of the docking lever 522 in the counterclockwise direction in response to the bias of the springs 523.

Downward movement of the pushbuttons 502 imparts rotation to the pawl shaft 518, which in turn releases the docking levers 522. In particular, each pushbutton 502 includes two angled surfaces 503, as shown in FIGS. 36B, 36C, 36E, and 36F. One of the angled surfaces 503 contacts the associated pin 516 as the pushbutton 502 is urged downward in relation to its associated bezel 540. The angled surface 503 urges the pin 516 downward. The downward movement of the pin 516 causes the shaft 518 to rotate in the clockwise direction (from the perspective of FIG. 34). The clockwise rotation of the pawls 520, in turn, causes the pawls 520 to release the docking levers 522, thereby permitting the docking levers 522 to move from their respective locking positions to their respective releasing positions in response to the bias of the springs 523. Movement of the docking levers 522 to their releasing positions permits the bracket member 200 to disengage from the device 10. Each pushbutton 502 can be depressed independent of the other pushbutton 502, and can thereby initiate the release the docking levers 522 independent of the other pushbutton 502.

The bracket member 200 can also be released using a cable 524. A portion of the cable 524 is visible in FIGS. 32, 33, 38, and 43A. A first end of the cable 524 is attached to a mechanical lever 525. The lever 525 is depicted in FIGS. 31-33, 43A, and 43B. The lever 525 is mounted on a housing 526 so that the lever 525 pivots in relation to the housing 526. The housing 526 can be mounted on a bracket 527. The bracket 527 can be mounted at a location on the transporting vehicle that facilitates access to the lever 525 by the user.

A second end of the cable 524 is attached to a bracket 528, as shown in FIGS. 32, 33, 38, 43A, and 43B. The bracket 528 is mounted between the yoke bracket 526 and one of the bezels 504. In particular, the bezels 504 each have two pins 532 formed thereon, as shown in FIG. 35. An end portion of each pin 532 becomes disposed in an associated hole formed in the yoke bracket 526 when the bezel 504 is mounted on the yoke bracket 526. The bracket 528 has two slots 534 incorporated therein, as shown in FIG. 38. Each slot 534 receives an associated one of the pins 532. The pins 532 restrain the bracket 528 in the vertical direction. The configuration of the slots 534 and the pins 532 facilitates translation of the bracket 528 in the forward and rearward directions.

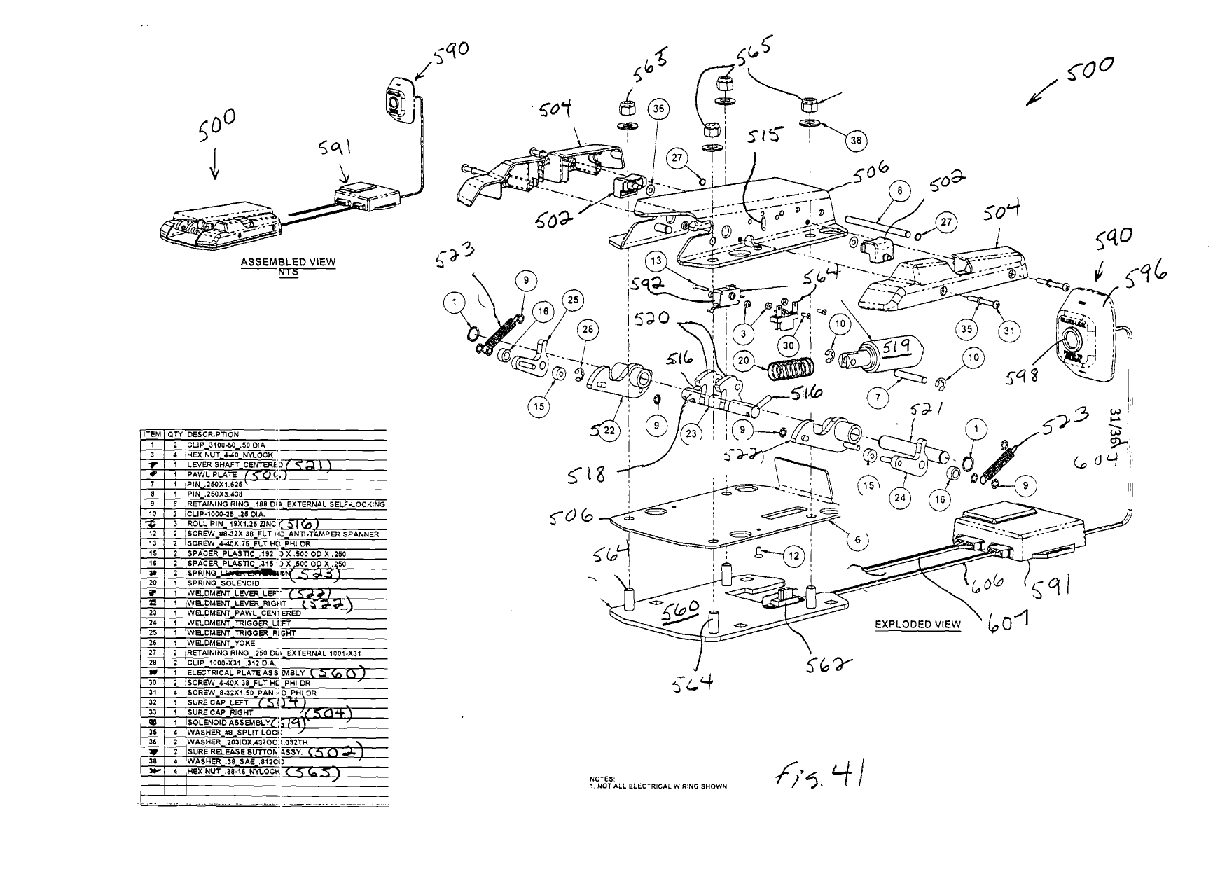

The bracket 528 includes a flange 536, as shown in FIGS. 38, 43A, and 43B. The flange 536 is oriented substantially perpendicular to the remainder of the bracket 528. The second end of the cable 524 extends through a hole formed in the bracket 528. The cable 524 can be equipped with a suitable means for preventing the second end of the cable 524 from backing out of the hole in the flange 536. For example, this function can be performed by a ball 538 secured to the second end of the cable 524, as shown in FIGS. 38 and 43B.

The cable 524 is encased in a sheath 539. A ferrule 540 is attached to the end of the sheath 539 associated with the second end of the cable 524, as shown in FIGS. 38, 43A, and 43B. A nut 542 is mated with the ferrule 540 using complementary threads on the nut 542 and the ferrule 540. The nut 542 is captured between two ribs 543 formed on the associated bezel 504. The ribs 543 are depicted in FIG. 35. The nut 542 facilitates adjustment of the position of the bracket 528 in relation to the yoke bracket 506 and the associated bezel 504.

A spring 544 is positioned between the flange 536 of the bracket 528 and the forward most rib 543. The spring 544 is depicted in FIGS. 38, 43A, and 43B, and biases the bracket 528 in the forward direction, i.e., in the leftward direction from the perspective of FIG. 38.

The bracket 528 has a cutout 550 incorporated therein. The cutout 550 has a substantially triangular shape, as shown in FIGS. 38, 43A, and 43B. In particular, the cutout 550 is defined by a first surface 551a, a second surface 551b, and a third surface 551c of the bracket 528. The first and second surfaces 551a, 551b are substantially perpendicular. The third surface 551c is angled in relation to the direction of travel of the bracket 528 as shown in FIG. 38.

The pin 514 mounted on the associated pushbutton 502 extends through the cutout 550. The bracket 528 causes the pin 514 to move downward when the cable 524 is actuated by the lever 525. In particular, moving an outwardly-facing end 525a of the lever 525 upward causes a portion of the cable 524 to retract into the housing 526. Retraction of the cable 524, in turn, causes the ball 538 attached the second end of the cable 524 to move rearward, against the flange 536 of the bracket 528. The rearward movement of the ball 538 urges the bracket 528 rearward.

The angled third surface 551c of the bracket 528 contacts the pin 514 as the bracket 528 moves in the rearward direction. The angled orientation of the surface 551c causes the surface 551c to urge the pin 514 on the associated pushbutton 502 downward as the bracket 528 moves rearward. The downward movement of the pin 514 imparts a corresponding downward movement to the pushbutton 502. The downward movement of the pushbutton 502 imparts rotation to the pawl shaft 518 by way of the pin 516, resulting in rotation of the pawl shaft 518 and release of the pawls 220 in the manner discussed above. The resulting movement of the docking levers 522 to their releasing positions permits the bracket member 200 to disengage from the device 500.

The device 500 can be mounted on a bracket 560, as shown in FIGS. 32, 33, 42A, and 42B. The bracket 560 has an electrical connector 562 mounted thereon. The electrical connector 562 mates with a complementary electrical connector 564 mounted on the yoke bracket 506 of the device 500 when the device 500 is positioned on the bracket 560. The electrical connectors 562, 564 are depicted in FIGS. 32-34, 38, 40-42B, and 44-46D. The electrical connectors 562, 564 facilitate the transmission of electrical signals and electrical power to and from the device 500. The use of the bracket 560 permits the device 500 to be removed from the transporting vehicle, and reinstalled or replaced without disconnecting, reconnecting, or otherwise disturbing the wires on the device 500 that transmit electrical signals and electrical power to and from the device 500.

The bracket 560 has threaded studs 564 mounted thereon, as shown in FIGS. 32, 33, and 40-42A. The studs 564 are disposed within associated through holes in the yoke bracket 506 when the yoke bracket 506 is positioned on the bracket 560. The studs 564 help to locate the device 500 on the bracket 560. Each stud 564 mates with a complementary nut 565 to secure the device 500 to the bracket 560.

The bracket 560 can be mounted on a spacer 568, if necessary, to adjust the height of the device 500 so that the device 500 is positioned at the proper height to receive the bracket member 200 during docking operations.

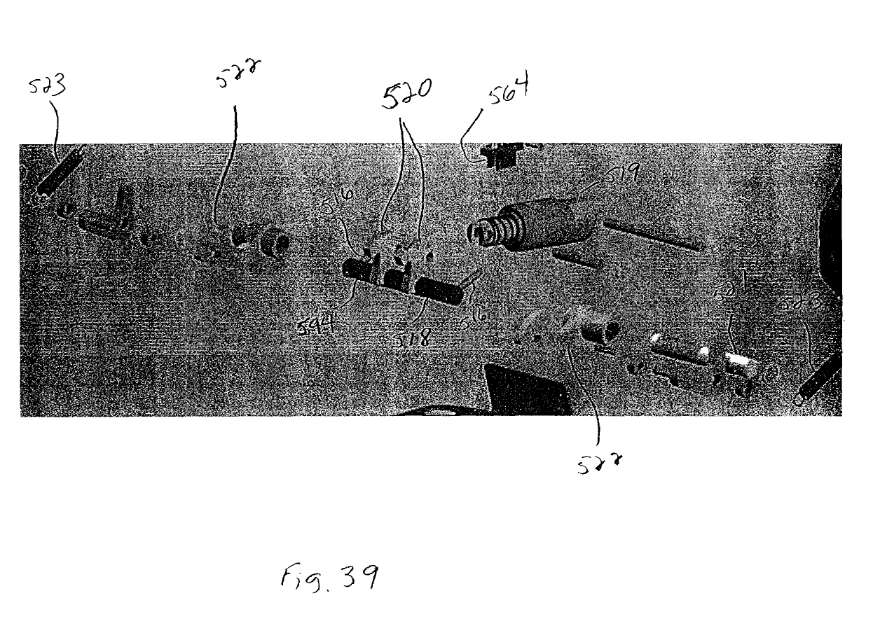

The spacer 568 can be mounted on a base 570 (the bracket 560 can be mounted directly on the base 570 if the spacer 568 is not used), as shown in FIGS. 32-34. The base 570 can be mounted on a suitable mounting surface of the transporting vehicle, such as the vehicle floorboard 571 shown in FIG. 34, using fasteners 572, nuts 574, and washers 576 shown in FIGS. 32 and 40.

The spacer 568 and the bracket 560 can be mounted on the base 570 using fasteners 580, washers 582, and nuts 585 that permit the positions of the spacer 568, the bracket 560, and the device 500 to be adjusted in relation to the vehicle floorboard 571 of the transporting vehicle, as follows.

The base 570 has four slots 584 incorporated therein. Each slot 584 has a plurality of large-width portions 586, and a plurality of small-width portions 588, as shown in FIG. 40. The large-width portions 586 and the small-width portions 588 are arranged in an alternating manner. The large-width portions 586 are sized so that the heads of the fasteners 580 can be inserted therethrough. Once the head of each fastener 580 has been inserted through one of the large-width portions 586, the fastener 580 can be moved to the adjacent small-width portion 588. The small-width portions 588 are sized to engage a square-shaped portion 585 formed on the fastener 580, proximate the head of thereof.

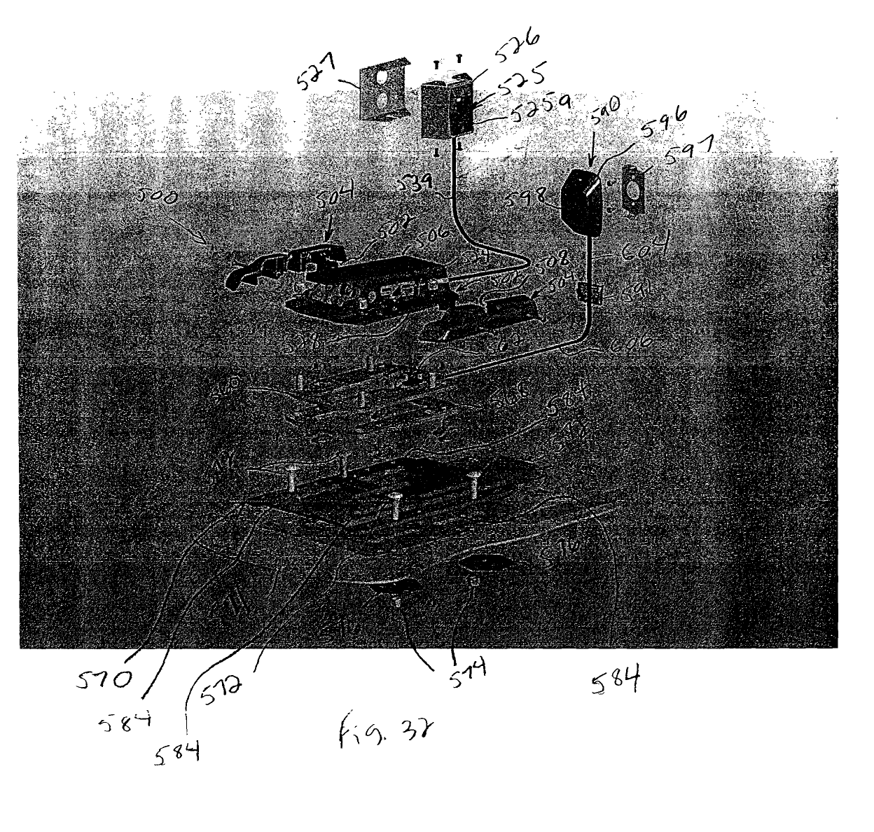

Each washer 582 can be inserted onto its associated fastener 580 as shown in FIGS. 32 and 33. Each washer 582 has tongue-shaped end portions 582a configured to fit snugly within the large-width portions 586 that border the small-diameter portion 588 in which the fastener 580 is disposed. The engagement of the end portions 582a of the washers 528 and the peripheral surfaces of the associated large-width portions 586 prevents the fasteners 580 from moving in the forward and rearward directions in relation to the base 570.

The spacer 568, the bracket 560, and the device 500 can subsequently be mounted on the base 570, so that the fasteners 580 extend through associated through holes formed in the spacer 568, the bracket 560, and the yoke bracket 506. The nuts 585 can then be mated with their associated fasteners 580 to secure the spacer 568, the bracket 560, and the device 500 to the base 570. The engagement of the square portion 585 of each fastener 580 and the peripheral surfaces of the associated small-with portion 588 prevents the fastener 580 from rotating as the associated nut 585 is tightened thereon.

Configuring each slot 584 with three small-width portions 588 permits the device 500 to be positioned in three different positions on the base 570. Alternative embodiments can be configured with more, or less than three of the small-width portions 588.

The device 500 can also include an electric release system. The electric release system includes a pushbutton module 590, a processor module 591, and a limit switch 592, as shown in FIGS. 31-33, 37, and 34.

The limit switch 592 is mounted on the yoke bracket 506 of the device 500, proximate the pawl shaft 518. The pawl shaft 518 has a pin 594 mounted thereon, as shown in FIG. 39. The limit switch 592 is positioned so that the pin 594 contacts and actuates the limit switch 592 when the pawls 520 are in their respective engaged positions. The pin 594 does not contact or actuate the limit switch 592 when the pawls are not in their respective engaged positions.

The pushbutton module 590 can be mounted at a location on the transporting vehicle that facilitates access to the pushbutton module 590 by the user. The pushbutton module 590 can include a housing 596, and a pushbutton-type switch 598 mounted on the housing 596, as shown in FIGS. 31-33, 42A, and 42B. The housing 596 can be mounted on a bracket 597, as shown in FIGS. 32 and 33. The bracket 597 can be mounted at a location on the transporting vehicle that facilitates access to the switch 598 by the user. The switch 598 can be illuminated by a light source such as a light emitting diode (LED) 599. The pushbutton module 590 can also include an audible alarm 600 mounted on the housing 596. The LED 599 and the audible alarm 600 are depicted in FIG. 37.

The processor module 591 includes a processor such as a microprocessor 602 shown in FIG. 37. The microprocessor 602 is communicatively coupled to the switch 598, the LED 599, and the audible alarm 600 of the pushbutton module 590 by a suitable means such as a multi-conductor electrical cable 604 shown in FIG. 31-33, 42A, and 42B. The microprocessor 602 is communicatively coupled to the limit switch 592 by a suitable means such as a multi-conductor electrical cable 606. The electrical cable 606 also transmits electrical power from the processor module 591 to the solenoid 519. The electrical cable 606 terminates with the electrical connector 562, so that the limit-switch signal and the electrical power are transmitted to the device 500 by way of the electrical connectors 562, 564.

Electrical power is supplied to the processor module 591 from a source of electrical power 611 on the transporting vehicle by way of a multi-conductor electrical cable 607. The electrical cable 607 also transmits a signal indicating whether the ignition switch of the transporting vehicle is in the “on” or “off” position.

The microprocessor 602 causes the LED 599 to illuminate in a steady green light when the signal from the limit switch 592 indicates that the pawls 520 are in their engaged positions, and the ignition switch 603 is in its “on” position. The microprocessor 602 also causes the LED 599 to illuminate in a steady green light whenever the ignition switch 603 is in its “off” position.

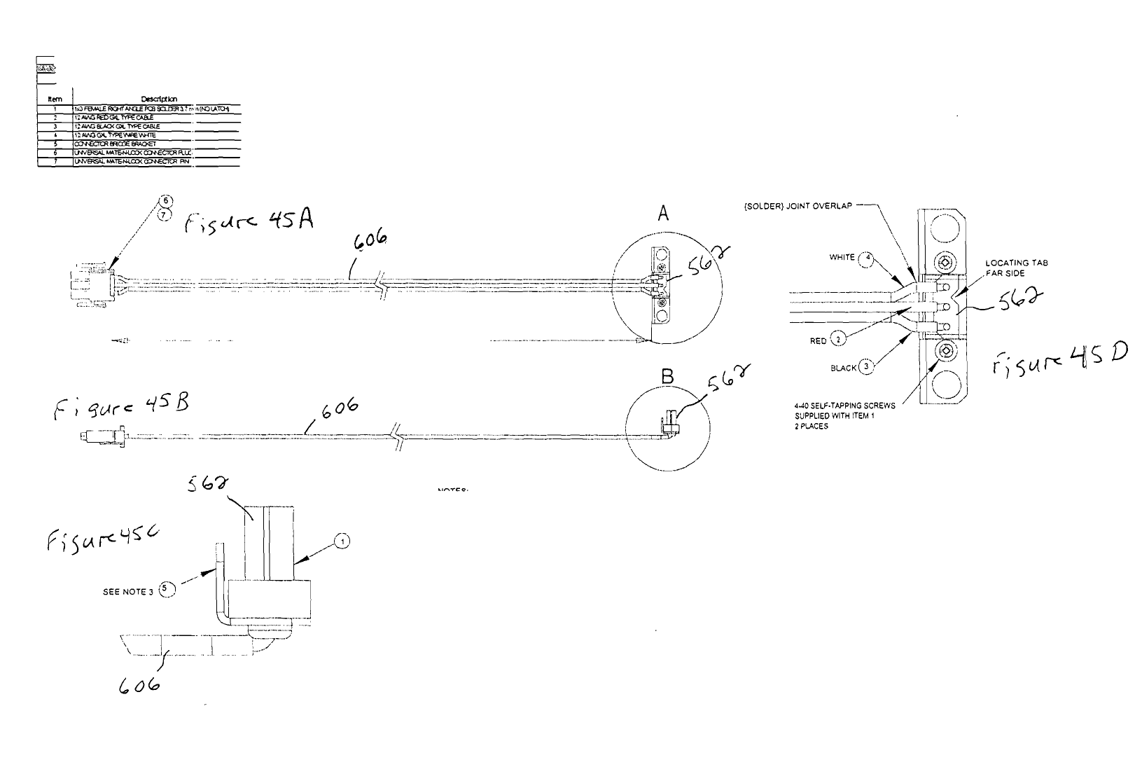

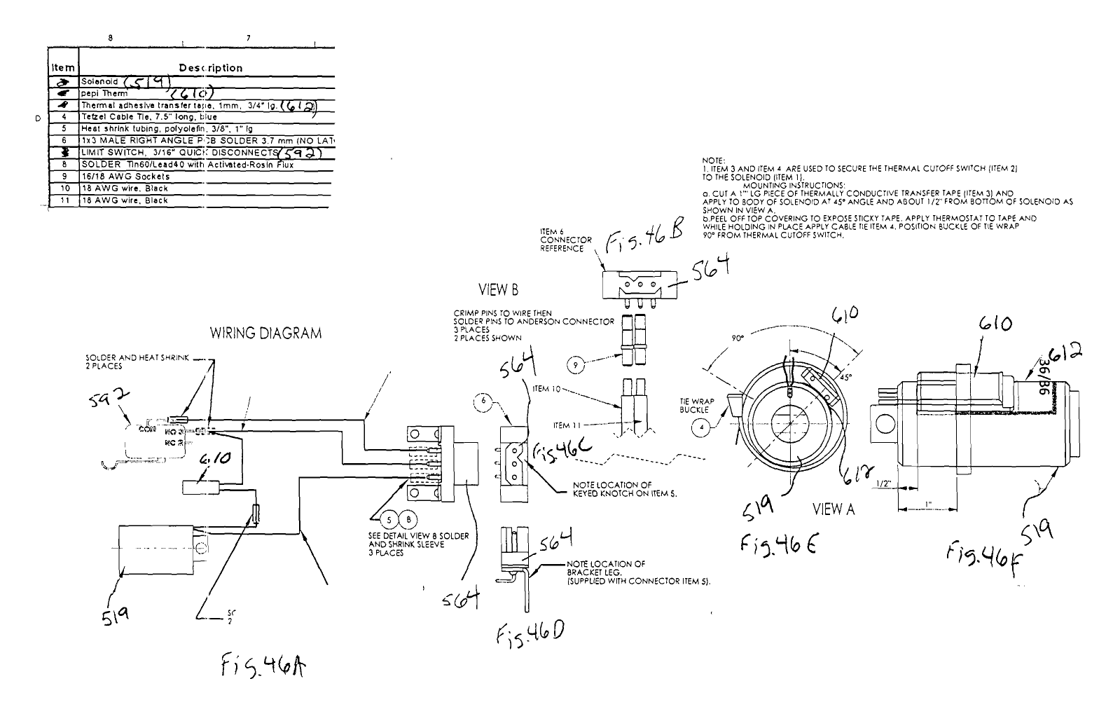

The electrical release system also includes a thermal cut-off switch 610 and a solenoid 519. The switch 610 is depicted in FIGS. 37, 46E, and 46F. The switch 610 can be mounted on the body of the solenoid 519 using a suitable means such as a two-sided adhesive strip 612 and a heat-resistant band.

The switch 610 is electrically connected in series with the solenoid 519 and the processing module 591, so that the electrical power supplied to the solenoid 519 from the processing module 591 passes through the switch 610. The switch 610 is normally in a closed position in which the switch 610 forms part of the conductive path between the solenoid 519 and the processing module 591. The switch 610 opens when the switch 610 senses that the surface temperature of the body of the solenoid 519 is approximately 120° F. or higher. Opening of the switch 610 interrupts the conductive path between the solenoid 519 and the processing module 591, thereby preventing actuation of the solenoid 519 when the temperature of the solenoid 519 is approximately 100° F. or higher.

Actuation of the solenoid 519 causes to pawls 520 to rotate about the centerline of the pawl shaft 518 in a clockwise direction, from the perspective of FIG. 34. Rotation of each pawl 520 away from its engaged position causes the pawl 520 to release its associated docking lever 522, thereby permitting the docking levers 522 to move to their respective releasing positions.

Depressing the pushbutton of the switch 598 causes the switch 598 to send a signal to the microprocessor 602. The microprocessor 602, upon receiving the signal from the switch 598, sends power to the solenoid 519 if the microprocessor 602 is receiving an indication that the ignition switch 603 of the transporting vehicle is in the “off” position. The power is transmitted to the solenoid 519 by way of the cable 606 and the electrical connectors 562, 564. The solenoid 519 is actuated upon being powered by the microprocessor 602.

The microprocessor 602 does not send power to the solenoid 519 if the switch 598 is depressed while the microprocessor 602 is receiving an indication that the ignition switch 603 of the transporting vehicle is in the “on” position. Thus, the microprocessor 602 does not facilitate activation of the solenoid 519 if the microprocessor 602 senses that the ignition switch 603 of the transporting vehicle is in the “on” position, thereby reducing of eliminating the potential for an inadvertent release of the plow bracket 200 (and the attached power personal-transport vehicle) while the transporting vehicle is moving.

Moreover, the microprocessor 602 generates an output signal that is transmitted to the pushbutton module 590 if the switch 598 is depressed while the microprocessor 602 is receiving an indication that the ignition switch 603 of the transporting vehicle is in the “on” position. The output signal, upon being received by the pushbutton module 590, causes the LED 599 of the pushbutton switch 598 to flash in red for approximately four seconds before returning to steady green, thereby providing a visual indication that the switch 598 has been depressed while the ignition switch 603 is in its “on” position.

The microprocessor 602 is also configured to cause the LED 599 to flash red, and to activate the audible alarm 600 if the ignition switch 603 of the transporting vehicle is in the “on” position, and the docking levers 522 are released manually using the pushbuttons 502 or the cable 524, as indicated by the output of the limit switch 592.

What is claimed is:

1. A device for securing a personal-transport vehicle to a mounting surface, comprising:
one of a plow bracket and a bracket member for mounting on one of the personal-transport vehicle and the mounting surface;
a receptacle for mating with the one of a plow bracket and a bracket member and comprising (i) a yoke bracket for mounting on the other of the personal-transport vehicle and the mounting surface and receiving the one of a plow bracket and a bracket member; and (ii) a docking lever pivotally coupled to the yoke bracket and movable between a first position wherein the docking lever can securely engage the one of a plow bracket and a bracket member and thereby retain the receptacle and the one of a plow bracket and a bracket member in a mated condition, and a second position;
a pawl assembly comprising: a shaft rotatably coupled to the yoke bracket; a pin mounted on the shaft; and a pawl mounted on the shaft so that the pawl can pivot between an engaged position wherein the pawl restrains the docking lever in the first position, and a disengaged position; and
a pushbutton coupled to the yoke bracket and movable between a first and a second position in relation to the yoke bracket, wherein the pushbutton engages the pin as the pushbutton moves between the first and second positions of the pushbutton so that movement of the pushbutton between the first and second positions of the pushbutton imparts rotation to the shaft that causes the pawl to pivot between the engaged and disengaged positions.

2. The device of claim 1, further comprising a bracket, and a pin mounted on the pushbutton and extending through an opening formed in the bracket and through a slot formed in the yoke member, wherein: the bracket is movable between a first and a second position; and the pin mounted on the pushbutton engages the bracket as the bracket moves between the first and second positions of the bracket so that movement of the bracket between the first and second positions of the bracket causes the pushbutton to move between the first and second positions of the pushbutton.

3. The device of claim 2, further comprising a bezel secured to the yoke member, wherein the bezel has a slot formed therein and the pushbutton is movably positioned within the slot.

4. The device of claim 2, further comprising a cable attached to the bracket for moving the bracket between the first and second positions of the bracket.

5. The device of claim 2, wherein: the opening formed in the bracket is defined in part by a first surface of the bracket; the first surface is oriented at an acute angle in relation to a direction of movement of the bracket between the first and second positions of the bracket; and the first surface engages the pin mounted on the pushbutton as the bracket moves between the first and second positions of the bracket.

6. The device of claim 5, wherein: the opening formed in the bracket is further defined by a second and a third surface of the bracket; the second surface is oriented substantially perpendicular to the direction of movement of the bracket between the first and second positions of the bracket; and the third surface is oriented substantially parallel to the direction of movement of the bracket between the first and second positions of the bracket.

7. The device of claim 3, wherein:
the pushbutton comprises a first and a second tab located on opposite sides of the pushbutton, and a projection;
the bezel comprises a first and a second rib that define a groove that receives the projection;
the bezel further comprises a third and a fourth rib; and
the first and second tabs ride against the respective third and fourth ribs as the pushbutton moves between the first and second positions of the pushbutton.

8. The device of claim 3, wherein: the bracket has a slot formed therein and the bezel has a pin formed thereon that extends through the slot formed in the bracket and guides the bracket as the bracket moves between the first and second positions of the bracket.

9. A device for securing a personal-transport vehicle to a mounting surface, comprising:
one of a plow bracket and a bracket member for mounting on the mounting surface;
a receptacle for mating with the one of a plow bracket and a bracket member and comprising (i) a yoke bracket for mounting on the personal-transport vehicle and receiving the one of a plow bracket and a bracket member; and (ii) a docking lever pivotally coupled to the yoke bracket and movable between a first position wherein the docking lever can securely engage the one of a plow bracket and a bracket member and thereby retain the receptacle and the one of a plow bracket and a bracket member in a mated condition, and a second position;
a pawl assembly comprising: a shaft rotatably coupled to the yoke bracket; and a pawl mounted on the shaft so that the pawl can pivot between an engaged position wherein the pawl restrains the docking lever in the first position, and a disengaged position;
a plurality of fasteners each having a head, a shaft, and a square portion located between the shaft and the head;
a plurality of washers each having two tongue-shaped end portions, and a middle portion capable of engaging an associated one of the fasteners; and
a base capable of being mounted on the mounting surface and supporting the receptacle on the mounting surface, wherein: the base has a plurality of slots formed therein; each of the slots has a plurality of small-width portions and a plurality of large-width portions arranged in an alternating manner; the large width portions are sized to permit the head of an associated one of the fasteners to pass therethrough; the small-width portions are sized to securely engage the square portion of an associated one of the fasteners; and the tongue-shaped portions of each of the washers are sized to fit snugly within the large-width portion of an associated one of the slots so that the washers prevent the fasteners from moving forward and rearward in relation to the base.

10. The device of claim 9, further comprising a mounting bracket mounted on the base and secured to the base by the fasteners, wherein the yoke bracket is mounted on the mounting bracket.

11. The device of claim 10, wherein the mounting bracket includes a plurality of threaded studs, and the yoke bracket has a plurality of holes formed therein that each receive a respective one of the threaded studs when the yoke bracket is mounted on the mounting bracket.

12. The device of claim 10, further comprising a first electrical connector mounted on the yoke bracket; and a second electrical connector mounted on the mounting bracket; wherein the first electrical connector mates with the second electrical connector when the yoke bracket is mounted on the mounting bracket.

13. The device of claim 10, further comprising a spacer capable of being positioned between the mounting bracket and the base to adjust a height of the receptacle above the mounting surface to a height that facilitates mating of the receptacle and the one of a plow bracket and a bracket member.

14. The device of claim 9, wherein each of the slots has three of the small-width portions so that the receptacle can be mounted in three different positions on the base.

15. A device for securing a personal-transport vehicle to a mounting surface of a transporting vehicle, comprising:
one of a plow bracket and a bracket member for mounting on one of the personal-transport vehicle and the mounting surface;
a receptacle for mating with the one of a plow bracket and a bracket member and comprising (i) a yoke bracket for mounting on the other of the personal-transport vehicle and the mounting surface and receiving the one of a plow bracket and a bracket member; and (ii) a docking lever pivotally coupled to the yoke bracket and movable between a first position wherein the docking lever can securely engage the one of a plow bracket and a bracket member and thereby retain the receptacle and the one of a plow bracket and a bracket member in a mated condition, and a second position;
a pawl assembly comprising: a shaft rotatably coupled to the yoke bracket; and a pawl mounted on the shaft so that the pawl can pivot between an engaged position wherein the pawl restrains the docking lever in the first position, and a disengaged position;
a solenoid mechanically coupled to the pawl assembly so that the solenoid causes the pawl to move to the disengaged position when the solenoid is activated; and
a release system comprising a pushbutton switch movable between a first and a second position, and a processor capable of being communicatively coupled to an ignition switch of the transporting vehicle, wherein the processor sends power to the solenoid to activate the solenoid when the pushbutton switch is moved to the second position and the ignition switch is an off position.

16. The device of claim 15, wherein the solenoid does not send power to the solenoid when the pushbutton switch is moved the second position and the ignition switch is an on position.

17. The device of claim 16, wherein the release system further comprises a light communicatively coupled to the processor, and the processor causes the light to flash for a predetermined time period when the switch is moved to the second position and the ignition switch is in the on position.

18. The device of claim 17, wherein the release system further comprises an audible alarm, and the processor activates the audible alarm and causes the light to flash when the pawl is moved to the disengaged position by a means other than the solenoid and the ignition switch is in the on position.

19. The device of claim 15, further comprising a thermal cut-off switch mounted on the solenoid, wherein the thermal cut-off switch assumes an open position when the temperature of the solenoid exceeds a predetermined level and thermal cut-off switch prevents the processor from sending power to the solenoid when the thermal cut-off switch is in the open position.

20. The device of claim 15, further comprising a limit switch communicatively coupled to the processor and mounted on the yoke member so that a pin mounted on the shaft activates the limit switch when the pawl is in the engaged position.
